(19) United States
(12) Patent Application Publication
(10) Pub. No.: US 2026/0251763 A1
(43) Pub. Date: Aug. 27, 2026

(54) SOLID-STATE LASER BEAM STEERING TECHNIQUES FOR FMCW LIDAR

(71) Applicant: Velodyne Lidar USA, Inc., San Jose, CA (US)

(72) Inventors: Amr Shaltout, Fremont, CA (US); Sunil Kumar Singh Khatana, Sunnyvale, CA (US); Nutan Gautam, Los Gatos, CA (US)

(21) Appl. No.: 18/871,111

(22) PCT Filed: Jun. 2, 2023
(86) PCT No.: PCT/US2023/067877

§ 371 Date: Dec. 2, 2024

Related U.S. Application Data
(60) Provisional application No. 63/349,026, filed on Jun. 3, 2022.

(51) Int. Cl. G01S 7/481; G01S 7/4911; G01S 7/4915; G01S 17/34; G01S 17/58; G01S 17/931

(52) U.S. Cl. CPC G01S 7/4814; G01S 7/4817; G01S 7/4911; G01S 7/4915; G01S 17/34; G01S 17/58; G01S 17/931

(57) ABSTRACT

A light detection and ranging (LiDAR) device including a laser source configured to provide a source beam having a modulated frequency. A plurality of optical antennas emit respective portions of light corresponding to the source beam and are positioned at discrete locations with respective separations between consecutive antennas. An optical feed structure provides respective portions of the source beam to the plurality of optical antennas such that each antenna receives a respective portion of the source beam with a different time delay, the time delays of consecutive antennas being separated by a time increment Δt corresponding to a frequency separation Δf of emitted light between the consecutive antennas. Respective portions of light emitted by the plurality of optical antennas interfere to produce a transmit beam and to provide beam steering of the transmit beam over a scan range.

### CROSS-REFERENCE TO RELATED APPLICATIONS

This application claims priority to and the benefit of U.S. Provisional Patent Application No. 63/349,026, titled “SOLID-STATE LASER BEAM STEERING TECHNIQUES FOR FMCW LIDAR” and filed on Jun. 3, 2022, the entire contents of which are hereby incorporated by reference herein.

### FIELD OF TECHNOLOGY

The present disclosure relates generally to light detection and ranging (“LiDAR”) technology and, more specifically, to solid-state laser beam steering techniques for frequency modulated continuous wave (FMCW) LiDAR systems.

### BACKGROUND

Light detection and ranging (“LiDAR”) systems measure the attributes of their surrounding environments (e.g., shape of a target, contour of a target, distance to a target, etc.) by illuminating the target with light (e.g., laser light) and measuring the reflected light with sensors. Differences in laser return times and/or wavelengths can then be used to make digital, three-dimensional (“3D”) representations of a surrounding environment. LiDAR technology may be used in various applications including autonomous vehicles, advanced driver assistance systems, mapping, security, surveying, robotics, geology and soil science, agriculture, and unmanned aerial vehicles, airborne obstacle detection (e.g., obstacle detection systems for aircraft), etc. Depending on the application and associated field of view, multiple channels or laser beams may be used to produce images in a desired resolution. A LiDAR system with greater numbers of channels can generally generate larger numbers of pixels.

In a multi-channel LiDAR device, optical transmitters can be paired with optical receivers to form multiple “channels.” In operation, each channel's transmitter can emit an optical signal (e.g., laser) into the device's environment, and the channel's receiver can detect the portion of the signal that is reflected back to the channel by the surrounding environment. In this way, each channel can provide “point” measurements of the environment, which can be aggregated with the point measurements provided by the other channel(s) to form a “point cloud” of measurements of the environment.

The measurements collected by a LiDAR channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the frequency (or wavelength) of the return signal(s) reflected by the surface.

In some cases, LiDAR measurements may be used to determine the reflectance of the surface that reflects an optical signal. The reflectance of a surface may be determined based on the intensity on the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

At least one aspect of the present disclosure is directed to a light detection and ranging (LiDAR) device. The LiDAR device includes at least one laser source configured to provide at least one source beam having a modulated frequency, a plurality of optical antennas configured to emit respective portions of light corresponding to the at least one source beam, the plurality of optical antennas being positioned at discrete locations with respective separations between consecutive antennas, and an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas, wherein the respective portions of light emitted by the plurality of optical antennas interfere to produce at least one transmit beam and to provide beam steering of the at least one transmit beam over a scan range.

Another aspect of the present disclosure is directed to a vehicle. The vehicle includes at least one LiDAR device configured to provide navigation and/or mapping for the vehicle, the at least one LiDAR device being disposed in an interior of the vehicle and/or on an exterior of the vehicle. Each LiDAR device includes at least one laser source configured to provide at least one source beam having a modulated frequency, a plurality of optical antennas configured to emit respective portions of light corresponding to the at least one source beam, the plurality of optical antennas being positioned at discrete locations with respective separations between consecutive antennas, and an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas, wherein the respective portions of light emitted by the plurality of optical antennas interfere to produce at least one transmit beam and to provide beam steering of the at least one transmit beam over a scan range.

Another aspect of the present disclosure is directed to a mobile robot. The mobile robot includes at least one LiDAR device configured to provide navigation and/or mapping for the mobile robot, the at least one LiDAR device being disposed in an interior of the mobile robot and/or on an exterior of the mobile robot. Each LiDAR device includes at least one laser source configured to provide at least one source beam having a modulated frequency, a plurality of optical antennas configured to emit respective portions of light corresponding to the at least one source beam, the plurality of optical antennas being positioned at discrete locations with respective separations between consecutive antennas, and an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas, wherein the respective portions of light emitted by the plurality of optical antennas interfere to produce at least one transmit beam and to provide beam steering of the at least one transmit beam over a scan range.

Another aspect of the present disclosure is directed to a method for operating a LiDAR device. The method includes providing, via at least one laser source, at least one source beam having a modulated frequency, emitting, via a plurality of optical antennas, respective portions of light corresponding to the at least one source beam, the plurality of optical antennas being positioned at discrete locations with respective separations between consecutive antennas, and providing, via an optical feed structure, respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas, wherein the respective portions of light emitted by the plurality of optical antennas interfere to produce at least one transmit beam and to provide beam steering of the at least one transmit beam over a scan range.

Another aspect of the present disclosure is directed to a silicon photonics (SiP) device. The SIP device includes a plurality of optical antennas configured to emit respective portions of light corresponding to at least one source beam having a modulated frequency, the plurality of optical antennas being positioned at discrete locations with respective separations between consecutive antennas, and an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas, wherein the respective portions of light emitted by the plurality of optical antennas interfere to produce at least one transmit beam and to provide beam steering of the at least one transmit beam over a scan range.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 shows an illustration of an exemplary LiDAR system, in accordance with some embodiments.

FIG. 2A shows an illustration of the operation of a LiDAR system, in accordance with some embodiments.

FIG. 2B shows an illustration of optical components of a channel of a LiDAR system with a movable mirror, in accordance with some embodiments.

FIG. 2C is an illustration of an example of a three-dimensional (“3D”) LiDAR system, in accordance with some embodiments.

FIG. 3 is an illustration of an example continuous wave (CW) coherent LiDAR system.

FIG. 4 is an illustration of an example frequency modulated continuous wave (FMCW) coherent LiDAR system.

FIG. 5A is a plot of a frequency chirp as a function of time in a transmitted laser signal and reflected signal.

FIG. 5B is a plot illustrating a beat frequency of a mixed signal.

FIG. 6 is a diagram of an FMCW coherent LiDAR system configured to determine the range and/or speed of a target.

FIG. 7A is a diagram of another FMCW coherent LiDAR system configured to determine the range and/or speed of a target.

FIG. 7B includes a plot illustrating a laser wavelength scheme.

FIG. 8 is a diagram of a method for operating a FMCW coherent LiDAR system.

FIG. 9 includes several plots illustrating a chirp scheme.

FIG. 10 includes several plots illustrating another chirp scheme.

FIG. 11 includes several plots illustrating yet another chirp scheme.

FIG. 12 is a diagram of yet another FMCW coherent LiDAR system configured to determine the range and/or speed of a target.

FIG. 13A is a diagram of a phase-arrayed source wherein each element of the array has a phase-shift with respect to adjacent elements.

FIG. 13B is a diagram of a frequency-arrayed source wherein each element of the array has a frequency shift with respect to adjacent elements.

FIG. 14 is a diagram illustrating a phase-locked array of cylindrical waves emanating from a plurality of sources.

FIG. 15 is a coordinate system used in mathematical formulations associated with FIGS. 13B and 14.

FIG. 16 is a plot of light intensity with respect to angle and time demonstrating a beam steering effect.

FIG. 17 illustrates simulation results for beam steering using the frequency arrayed source of FIG. 13B.

FIG. 18A is a diagram of an FMCW coherent LiDAR system configured to determine the range of a target in accordance with aspects described herein.

FIG. 18B is a graph illustrating frequency chirps as a function of time for the LiDAR system of FIG. 18A.

FIG. 19A is a diagram of an FMCW coherent LiDAR system configured to determine the range and/or velocity of a target in accordance with aspects described herein.

FIG. 19B is a graph illustrating frequency chirps as a function of time for the LiDAR system of FIG. 19A.

FIG. 20 is another graph illustrating frequency chirps as a function of time for the LiDAR system of FIG. 19A.

FIG. 21 is a block diagram of a silicon photonic integrated circuit (PIC) in accordance with aspects described herein.

FIG. 22A is a diagram of an example optical feed structure for the PIC of FIG. 21 in accordance with aspects described herein.

FIG. 22B is a diagram of another example optical feed structure for the PIC of FIG. 21 in accordance with aspects described herein.

FIG. 23A is a diagram of another example optical feed structure for the PIC of FIG. 21 in accordance with aspects described herein.

FIG. 23B is a diagram of another example optical feed structure for the PIC of FIG. 21 in accordance with aspects described herein.

FIG. 24 is a diagram of another example optical feed structure for the PIC of FIG. 21 in accordance with aspects described herein.

FIG. 25 is a block diagram of another silicon PIC in accordance with aspects described herein.

FIG. 26 is a diagram of a vehicle including a plurality of sensors in accordance with aspects described herein.

FIG. 27 shows a block diagram of a computing device/information handling system, in accordance with some embodiments.

FIG. 28 is a block diagram of an example computer system.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Solid-state laser beam steering techniques for frequency modulated continuous wave (FMCW) LiDAR systems are provided herein. It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

### Motivation for and Benefits of Some Embodiments

FMCW coherent LiDAR systems can avoid the eye safety hazards commonly associated with pulsed LiDAR systems (e.g., hazards that arise from transmitting optical signals with high peak power). In addition, coherent detection may be more sensitive than direct detection and can offer better performance, including single-pulse velocity measurement and greater immunity to interference from solar glare and other light sources, including other LiDAR systems and devices. However, FMCW LiDAR systems typically rely on the use of mechanical beam steering components (e.g., rotors, actuators, motors, flexures, micro-electromechanical systems (MEMS), etc.) that can increase the size and cost of LiDAR systems. As such, the size, cost, reliability, and/or performance of FMCW LiDAR systems may be improved through the use of solid-state beam steering techniques.

### Some Examples of LiDAR Systems

A light detection and ranging (“LiDAR”) system may be used to measure the shape and contour of the environment surrounding the system. LiDAR systems may be applied to numerous applications including autonomous navigation and aerial mapping of surfaces. In general, a LiDAR system emits light that is subsequently reflected by objects within the environment in which the system operates. In some examples, the LiDAR system is configured to emit light pulses. The time each pulse travels from being emitted to being received (i.e., time-of-flight, “TOF” or “ToF”) may be measured to determine the distance between the LiDAR system and the object that reflects the pulse. In other examples, the LiDAR system can be configured to emit continuous wave (CW) light. The wavelength (or frequency) of the received, reflected light may be measured to determine the distance between the LiDAR system and the object that reflects the light. In some examples, LiDAR systems can measure the speed (or velocity) of objects. The science of LiDAR systems is based on the physics of light and optics.

In a LiDAR system, light may be emitted from a rapidly firing laser. Laser light travels through a medium and reflects off points of surfaces in the environment (e.g., surfaces of buildings, tree branches, vehicles, etc.). The reflected light energy returns to a LiDAR detector where it may be recorded and used to map the environment.

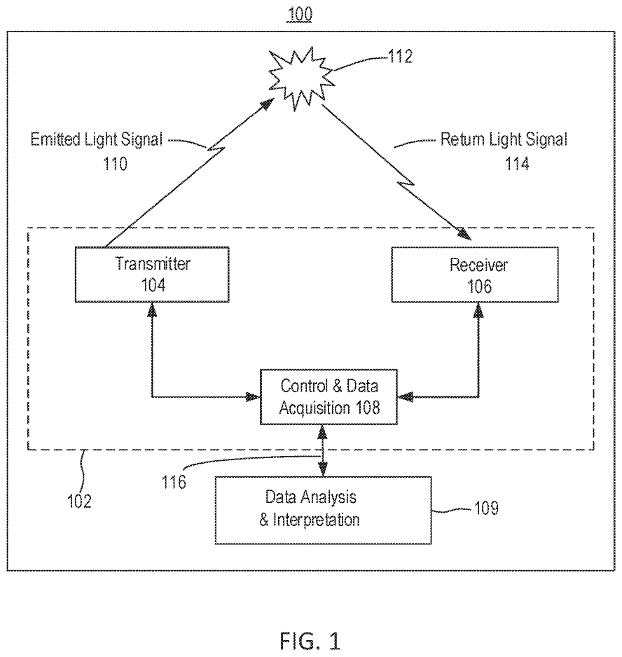

FIG. 1 depicts the operation of a LiDAR system 100, according to some embodiments. In the example of FIG. 1, the LiDAR system 100 includes a LiDAR device 102, which may include a transmitter 104 that generates and emits a light signal 110, a receiver 106 that detects a return light signal 114, and a control & data acquisition module 108. The transmitter 104 may include a light source (e.g., laser), electrical components operable to activate (“drive”) and deactivate the light source in response to electrical control signals, and optical components adapted to shape and redirect the light emitted by the light source. The receiver 106 may include an optical detector (e.g., photodiode) and optical components adapted to shape return light signals 114 and direct those signals to the detector. In some implementations, one or more of optical components (e.g., lenses, mirrors, etc.) may be shared by the transmitter and the receiver. The LiDAR device 102 may be referred to as a LiDAR transceiver or “channel.” In operation, the emitted (e.g., illumination) light signal 110 propagates through a medium and reflects off an object(s) 112, whereby a return light signal 114 propagates through the medium and is received by receiver 106. In one example, each LiDAR channel may correspond to a physical mapping of a single emitter to a single detector (e.g., a one-to-one pairing of a particular emitter and a particular detector). However, in other examples, each LiDAR channel may correspond to a physical mapping of multiple emitters to a single detector or a physical mapping of a single emitter to multiple detectors (e.g., a “flash” configuration). In some examples, a LiDAR system 100 may have no fixed channels; light emitted by one or more emitters may be detected by one or more detectors without any physical or persistent mapping of specific emitters to specific detectors.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 determines (e.g., measures) particular characteristics of the return light signal 114 detected by the receiver 106. For example, the control & data acquisition module 108 may measure the intensity of the return light signal 114 using any suitable technique.

A LiDAR transceiver 102 may include one or more optical lenses and/or mirrors (not shown) to redirect and shape the emitted light signal 110 and/or to redirect and shape the return light signal 114. The transmitter 104 may emit a laser beam (e.g., a beam having a plurality of pulses in a particular sequence). Design elements of the receiver 106 may include its horizontal field of view (hereinafter, “FOV”) and its vertical FOV. One skilled in the art will recognize that the FOV parameters effectively define the visibility region relating to the specific LiDAR transceiver 102. More generally, the horizontal and vertical FOVs of a LiDAR system 100 may be defined by a single LiDAR device (e.g., sensor) or may relate to a plurality of configurable sensors (which may be exclusively LiDAR sensors or may have different types of sensors). The FOV may be considered a scanning area for a LiDAR system 100. A scanning mirror and/or rotating assembly may be utilized to obtain a scanned FOV.

In some implementations, the LiDAR system 100 may include or be electronically coupled to a data analysis & interpretation module 109, which may receive outputs (e.g., via connection 116) from the control & data acquisition module 108 and perform data analysis functions on those outputs. The connection 116 may be implemented using a wireless or non-contact communication technique.

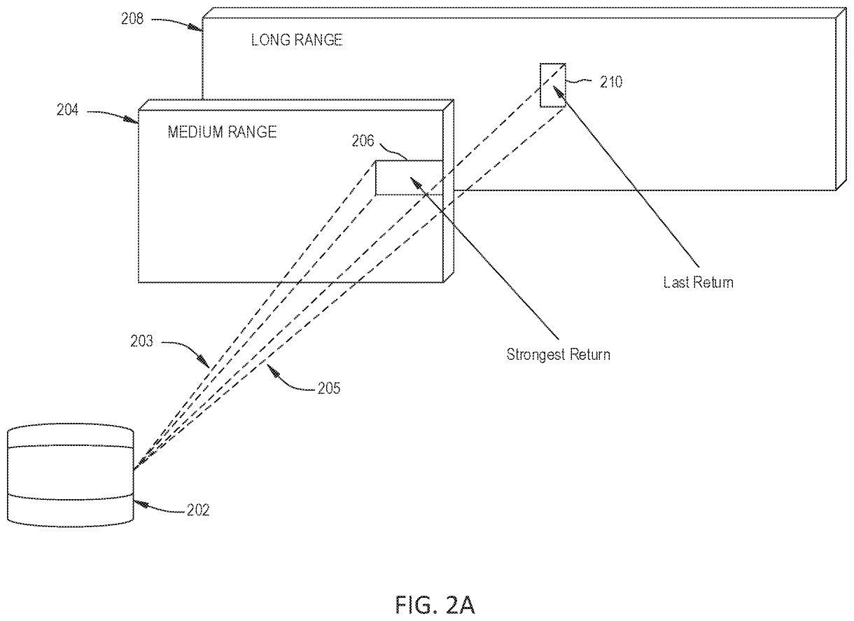

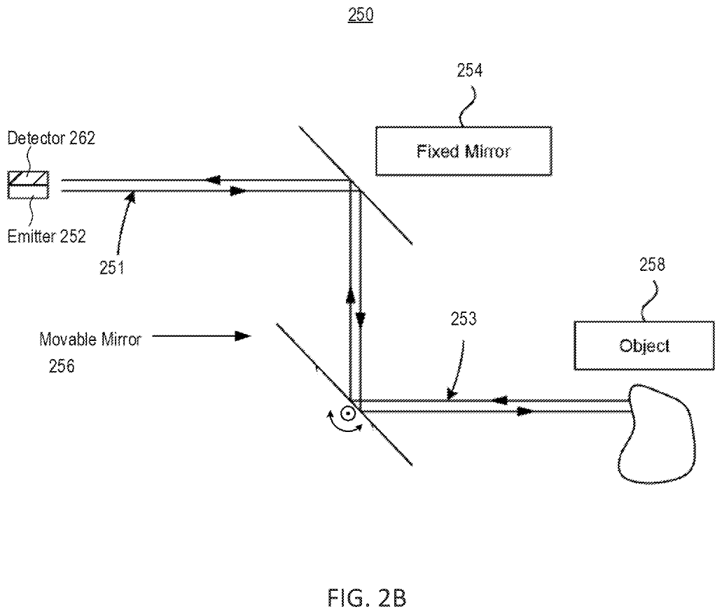

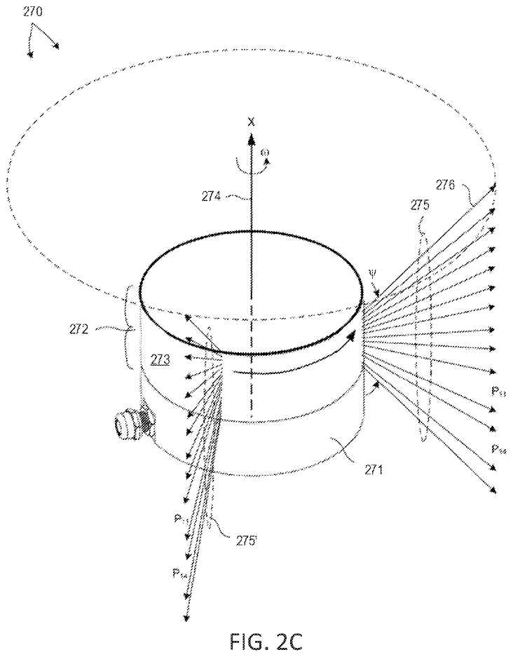

FIG. 2A illustrates the operation of a LiDAR system 202, in accordance with some embodiments. In the example of FIG. 2A, two return light signals 203 and 205 are shown. Laser beams generally tend to diverge as they travel through a medium. Due to the laser's beam divergence, a single laser emission may hit multiple objects at different ranges from the LiDAR system 202, producing multiple return signals 203, 205. The LiDAR system 202 may analyze multiple return signals 203, 205 and report one of the return signals (e.g., the strongest return signal, the last return signal, etc.) or more than one (e.g., all) of the return signals. In the example of FIG. 2A, LiDAR system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and a stronger received signal strength compared with return signal 205. In both single- and multiple-return LiDAR systems, it is important that each return signal is accurately associated with the transmitted light signal so that one or more attributes of the object that reflect the light signal (e.g., range, velocity, reflectance, etc.) can be correctly calculated.

Some embodiments of a LiDAR system may capture distance data in a two-dimensional (2D) (e.g., single plane) point cloud manner. These LiDAR systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the LiDAR system to achieve 90-180-360 degrees of azimuth (horizontal) view while simplifying both the system design and manufacturability. Many applications require more data than just a 2D plane. The 2D point cloud may be expanded to form a three-dimensional (“3D”) point cloud, in which multiple 2D point clouds are used, each pointing at a different elevation (e.g., vertical) angle. Design elements of the receiver of the LiDAR system 202 may include the horizontal FOV and the vertical FOV.

FIG. 2B depicts a LiDAR system 250 with a movable (e.g., oscillating) mirror, according to some embodiments. In the example of FIG. 2B, the LiDAR system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. Design elements of the LiDAR system 250 include the horizontal FOV and the vertical FOV, which define a scanning area.

FIG. 2C depicts a 3D LiDAR system 270, according to some embodiments. In the example of FIG. 2C, the 3D LiDAR system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D LiDAR system 270 includes a LiDAR transceiver 102 operable to emit laser beams 276 through the cylindrical shell element 273 of the upper housing 272. In the example of FIG. 2C, each individual arrow in the sets of arrows 275, 275′ directed outward from the 3D LiDAR system 270 represents a laser beam 276 emitted by the 3D LiDAR system. Each beam of light emitted from the system 270 may diverge slightly, such that each beam of emitted light forms a cone of illumination light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D LiDAR system 270. The direction of each emitted beam may be determined by the angular orientation ω of the transceiver's transmitter 104 with respect to the system's central axis 274 and by the angular orientation ψ of the transmitter's movable mirror 256 with respect to the mirror's axis of oscillation (or rotation). For example, the direction of an emitted beam in a horizontal dimension may be determined by the transmitter's angular orientation ω, and the direction of the emitted beam in a vertical dimension may be determined by the angular orientation ψ of the transmitter's movable mirror. Alternatively, the direction of an emitted beam in a vertical dimension may be determined the transmitter's angular orientation ω, and the direction of the emitted beam in a horizontal dimension may be determined by the angular orientation ψ of the transmitter's movable mirror. (For purposes of illustration, the beams of light 275 are illustrated in one angular orientation relative to a non-rotating coordinate frame of the 3D LiDAR system 270 and the beams of light 275′ are illustrated in another angular orientation relative to the non-rotating coordinate frame.)

The 3D LiDAR system 270 may scan a particular point (e.g., pixel) in its field of view by adjusting the orientation ω of the transmitter and the orientation ψ of the transmitter's movable mirror to the desired scan point (ω, ψ) and emitting a laser beam from the transmitter 104. Likewise, the 3D LiDAR system 270 may systematically scan its field of view by adjusting the orientation ω of the transmitter and the orientation ψ of the transmitter's movable mirror to a set of scan points (ωᵢ, ψⱼ) and emitting a laser beam from the transmitter 104 at each of the scan points.

Assuming that the optical component(s) (e.g., movable mirror 256) of a LiDAR transceiver remain stationary during the time period after the transmitter 104 emits a laser beam 110 (e.g., a pulsed laser beam or “pulse” or a CW laser beam) and before the receiver 106 receives the corresponding return beam 114, the return beam generally forms a spot centered at (or near) a stationary location L0 on the detector. This time period is referred to herein as the “ranging period” of the scan point associated with the transmitted beam 110 and the return beam 114.

In many LiDAR systems, the optical component(s) of a LiDAR transceiver do not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location “Li” of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the transmitted light. The distance between the location “Li” of the spot formed by the return beam and the nominal location “L0” of the spot that would have been formed absent the intervening rotation of the optical component(s) during the ranging period is referred to herein as “walk-off.”

### Some Examples of Continuous Wave (CW) LiDAR Systems

As discussed above, some LiDAR systems may use a continuous wave (CW) laser to detect the range and/or velocity of targets, rather than pulsed TOF techniques. Such systems include continuous wave (CW) coherent LiDAR systems and frequency modulated continuous wave (FMCW) coherent LiDAR systems. For example, any of the LiDAR systems 100, 202, 250, and 270 described above can be configured to operate as a CW coherent LiDAR system or an FMCW coherent LiDAR system.

LiDAR systems configured to operate as CW or FMCW systems can avoid the eye safety hazards of high peak powers associated with pulsed LiDAR systems. In addition, coherent detection may be more sensitive than direct detection and can offer better performance, including single-pulse velocity measurement and immunity to interference from solar glare and other light sources-including other LiDAR systems and devices.

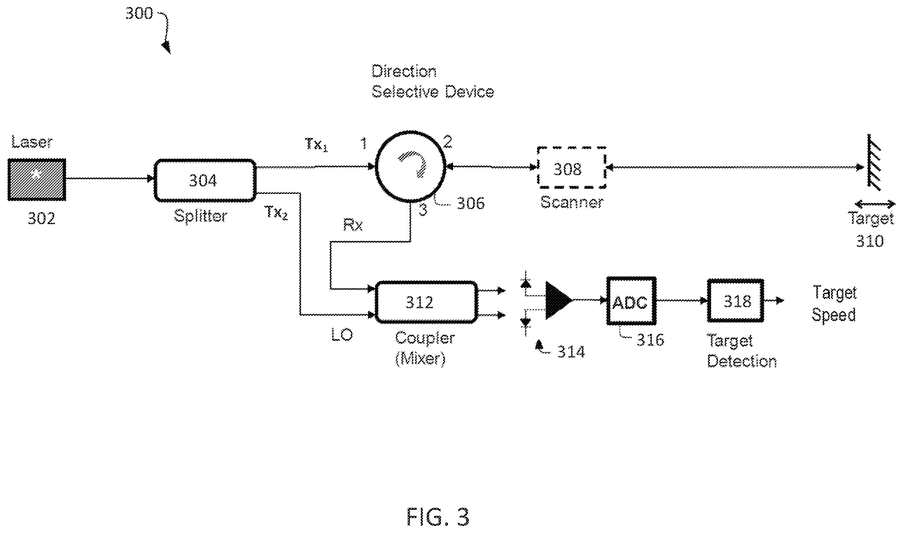

FIG. 3 illustrates an exemplary CW coherent LiDAR system 300 configured to determine the radial velocity of a target. LiDAR system 300 includes a laser 302 configured to produce a laser signal which is provided to a splitter 304. The laser 302 may provide a laser signal having a substantially constant laser frequency.

In one example, a splitter 304 provides a first split laser signal Tx1 to a direction selective device 306, which provides (e.g., forwards) the signal Tx1 to a scanner 308. In some examples, the direction selective device 306 is a circulator. The scanner 308 uses the first laser signal Tx1 to transmit light emitted by the laser 302 and receives light reflected by the target 310 (e.g., “reflected light” or “reflections”). The reflected light signal Rx is provided (e.g., passed back) to the direction selective device 306. The second laser signal Tx2 and reflected light signal Rx are provided to a coupler (also referred to as a mixer) 312. The mixer may use the second laser signal Tx2 as a local oscillator (LO) signal and mix it with the reflected light signal Rx. The mixer 312 may be configured to mix the reflected light signal Rx with the local oscillator signal LO. The mixer 312 may provide the mixed optical signal to differential photodetector 314, which may generate an electrical signal representing the beat frequency f_{beat} of the mixed optical signals, where f_{beat}=|f_{Tx2}−f_{Rx}| (the absolute value of the difference between the frequencies of the mixed optical signals). In some embodiments, the current produced by the differential photodetector 314 based on the mixed light may have the same frequency as the beat frequency f_{beat}. The current may be converted to voltage by an amplifier (e.g., transimpedance amplifier (TIA)), which may be provided (e.g., fed) to an analog-to-digital converter (ADC) 316 configured to convert the analog voltage signal to digital samples for a target detection module 318. The target detection module 318 may be configured to determine (e.g., calculate) the radial velocity of the target 310 based on the digital sampled signal with beat frequency f_{beat}.

In one example, the target detection module 318 may identify Doppler frequency shifts using the beat frequency f_{beat} and determine the radial velocity of the target 310 based on those shifts. For example, the velocity of the target 310 can be calculated using the following relationship:

$${f}_{d} = \frac{2}{λ} {v}_{t}$$

where, f_{d} is the Doppler frequency shift, λ is the wavelength of the laser signal, and vₜ is the radial velocity of the target 310. In some examples, the direction of the target 310 is indicated by the sign of the Doppler frequency shift fa. For example, a positive signed Doppler frequency shift may indicate that the target 310 is traveling towards the system 300 and a negative signed Doppler frequency shift may indicate that the target 310 is traveling away from the system 300.

In one example, a Fourier Transform calculation is performed using the digital samples from the ADC 316 to recover the desired frequency content (e.g., the Doppler frequency shift) from the digital sampled signal. For example, a controller (e.g., target detection module 318) may be configured to perform a Discrete Fourier Transform (DFT) on the digital samples. In certain examples, a Fast Fourier Transform (FFT) can be used to calculate the DFT on the digital samples. In some examples, the Fourier Transform calculation (e.g., DFT) can be performed iteratively on different groups of digital samples to generate a target point cloud.

While the LiDAR system 300 is described above as being configured to determine the radial velocity of a target, it should be appreciated that the system can be configured to determine the range and/or radial velocity of a target. For example, the LIDAR system 300 can be modified to use laser chirps to detect the velocity and/or range of a target.

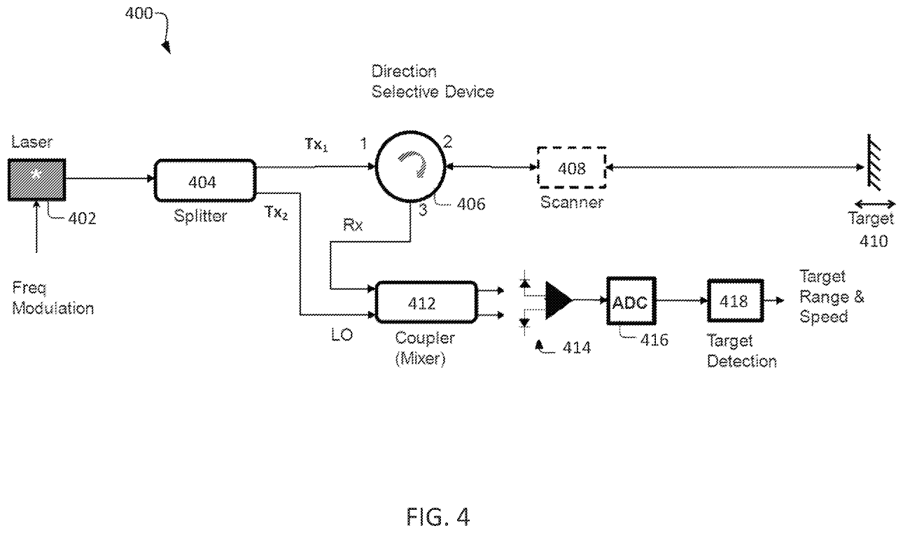

FIG. 4 illustrates an exemplary FMCW coherent LiDAR system 400 configured to determine the range and/or radial velocity of a target. LiDAR system 400 includes a laser 402 configured to produce a laser signal which is fed into a splitter 404. The laser is “chirped” (e.g., the center frequency of the emitted laser beam is increased (“ramped up” or “chirped up”) or decreased (“ramped down” or “chirped down”) over time or, equivalently, the central wavelength of the emitted laser beam changes with time within a waveband). In various embodiments, the laser frequency is chirped quickly such that multiple phase angles are attained. In one example, the frequency of the laser signal is modulated by changing the laser operating parameters (e.g., current/voltage) or using a modulator included in the laser source 402; however, in other examples, an external modulator can be placed between the laser source 402 and the splitter 404.

In other examples, the laser frequency can be “chirped” by modulating the phase of the laser signal (or light) produced by the laser 402. In one example, the phase of the laser signal is modulated using an external modulator placed between the laser source 402 and the splitter 404; however, in some examples, the laser source 402 may be modulated directly by changing operating parameters (e.g., current/voltage) or include an internal modulator. Similar to frequency chirping, the phase of the laser signal can be increased (“ramped up”) or decreased (“ramped down”) over time.

Some examples of systems with FMCW-based LiDAR sensors have been described. However, some embodiments of the techniques described herein may be implemented using any suitable type of LiDAR sensors including, without limitation, any suitable type of coherent LiDAR sensors (e.g., phase-modulated coherent LiDAR sensors). With phase-modulated coherent LiDAR sensors, rather than chirping the frequency of the light produced by the laser (as described above with reference to FMCW techniques), the LiDAR system may use a phase modulator placed between the laser 402 and the splitter 404 to generate a discrete phase modulated signal, which may be used to measure range and radial velocity.

As shown, the splitter 404 provides a first split laser signal Tx1 to a direction selective device 406, which provides (e.g., forwards) the signal Tx1 to a scanner 408. The scanner 408 uses the first laser signal Tx1 to transmit light emitted by the laser 402 and receives light reflected by the target 410. The reflected light signal Rx is provided (e.g., passed back) to the direction selective device 406. The second laser signal Tx2 and reflected light signal Rx are provided to a coupler (also referred to as a mixer) 412. The mixer may use the second laser signal Tx2 as a local oscillator (LO) signal and mix it with the reflected light signal Rx. The mixer 412 may be configured to mix the reflected light signal Rx with the local oscillator signal LO to generate a beat frequency f_{beat}. The mixed signal with beat frequency f_{beat} may be provided to a differential photodetector 414 configured to produce a current based on the received light. The current may be converted to voltage by an amplifier (e.g., a transimpedance amplifier (TIA)), which may be provided (e.g., fed) to an analog-to-digital converter (ADC) 416 configured to convert the analog voltage to digital samples for a target detection module 418. The target detection module 418 may be configured to determine (e.g., calculate) the range and/or radial velocity of the target 410 based on the digital sampled signal with beat frequency f_{beat}.

Laser chirping may be beneficial for range (distance) measurements of the target. In comparison, Doppler frequency measurements are generally used to measure target velocity. Resolution of distance can depend on the bandwidth size of the chirp frequency band such that greater bandwidth corresponds to finer resolution, according to the following relationships:

$$Range Resolution : Δ R = \frac{c}{2 BW} ( given a perfectly linear chirp ) , and \\ Range : R = \frac{{f}_{beat} c {T}_{ChirpRamp}}{2 BW}$$

where c is the speed of light, BW is the bandwidth of the chirped laser signal, f_{beat} is the beat frequency, and T_{ChirpRamp} is the time period during which the frequency of the chirped laser ramps up (e.g., the time period corresponding to the up-ramp portion of the chirped laser). For example, for a distance resolution of 3.0 cm, a frequency bandwidth of 5.0 GHz may be used. A linear chirp can be an effective way to measure range and range accuracy can depend on the chirp linearity. In some instances, when chirping is used to measure target range, there may be range and velocity ambiguity. In particular, the reflected signal for measuring velocity (e.g., via Doppler) may affect the measurement of range. Therefore, some exemplary FMCW coherent LiDAR systems may rely on two measurements having different slopes (e.g., negative and positive slopes) to remove this ambiguity. The two measurements having different slopes may also be used to determine range and velocity measurements simultaneously.

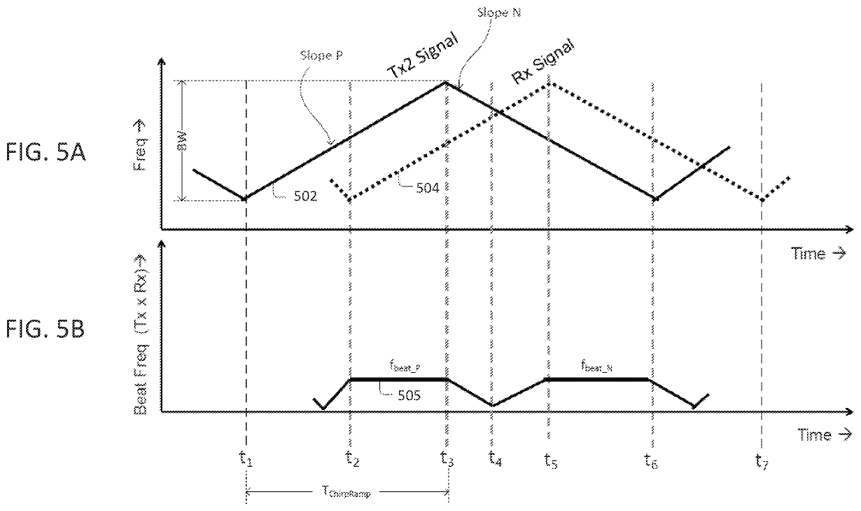

FIG. 5A is a plot of ideal (or desired) frequency chirp as a function of time in the transmitted laser signal Tx (e.g., signal Tx2), depicted in solid line 502, and reflected light signal Rx, depicted in dotted line 504. As depicted, the ideal Tx signal has a positive linear slope between time t1 and time t3 and a negative linear slope between time t3 and time t6. Accordingly, the ideal reflected light signal Rx returned with a time delay td of approximately t2−t1 has a positive linear slope between time t2 and time t5 and a negative linear slope between time t5 and time t7.

FIG. 5B is a plot illustrating the corresponding ideal beat frequency f_{beat} 506 of the mixed signal Tx2×Rx. Note that the beat frequency f_{beat} 506 has a constant value between time t2 and time t3 (corresponding to the overlapping up-slopes of signals Tx2 and Rx) and between time t5 and time t6 (corresponding to the overlapping down-slopes of signals Tx2 and Rx).

The positive slope (“Slope P”) and the negative slope (“Slope N”) (also referred to as positive ramp (or up-ramp) and negative ramp (or down-ramp), respectively) can be used to determine range and/or velocity. In some instances, referring to FIGS. 5A-5B, when the positive and negative ramp pair is used to measure range and velocity simultaneously, the following relationships are utilized:

$$Range : R = \frac{{cT}_{ChirpRamp} \frac{( {f}_{beat\_P} + {f}_{beat\_N} )}{2}}{2 BW} , \\ and \\ Velocity : V = \frac{λ \frac{( {f}_{beat\_P} + {f}_{beat\_N} )}{2}}{2}$$

where f_{beat_P} and f_{beat_N} are beat frequencies generated during positive (P) and negative (N) slopes of the chirp 502 respectively and λ is the wavelength of the laser signal.

In one example, the scanner 408 of the LiDAR system 400 is used to scan the environment and generate a target point cloud from the acquired scan data. In some examples, the LiDAR system 400 can use processing methods that include performing one or more Fourier Transform calculations, such as a Fast Fourier Transform (FFT) or a Discrete Fourier Transform (DFT), to generate the target point cloud from the acquired scan data. Being that the system 400 is capable of measuring range, each point in the point cloud may have a three-dimensional location (e.g., x, y, and z) in addition to radial velocity. In some examples, the x-y location of each target point corresponds to a radial position of the target point relative to the scanner 408. Likewise, the z location of each target point corresponds to the distance between the target point and the scanner 408 (e.g., the range). In one example, each target point corresponds to one frequency chirp 502 in the laser signal. For example, the samples collected by the system 400 during the chirp 502 (e.g., t1 to t6) can be processed to generate one point in the point cloud.

### Some Examples of High-Resolution Continuous Wave (CW) LiDAR Systems

In some examples, coherent LiDAR systems can include two lasers configured to provide separate frequency chirps in parallel to determine the range and/or speed (or velocity) of a target. In certain examples, the lasers may be configured to operate at different wavelengths with different rates of frequency movement.

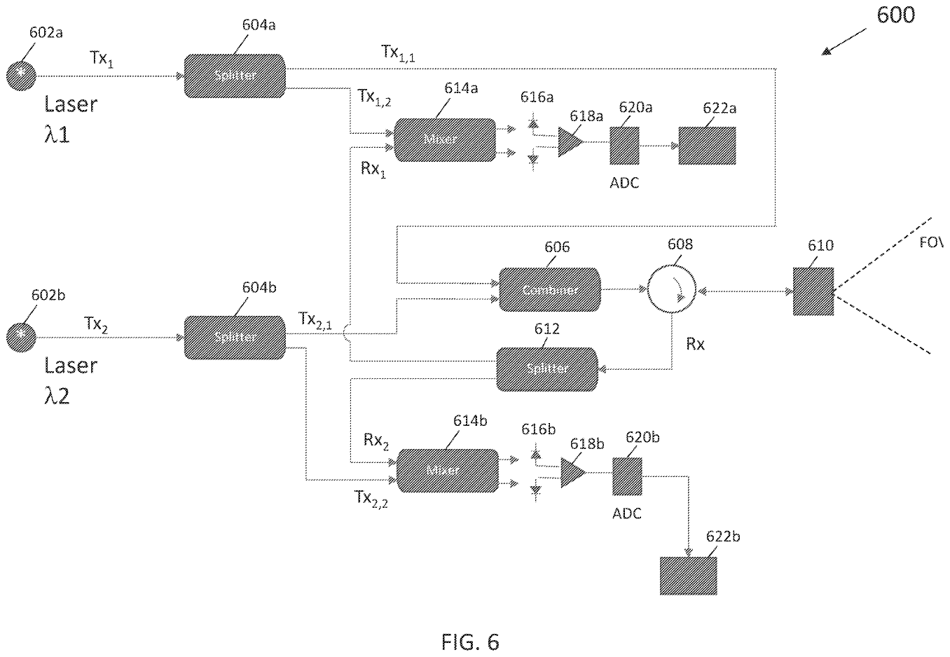

FIG. 6 illustrates a FMCW coherent LiDAR system 600 configured to determine the range and/or speed (or velocity) of a target in accordance with aspects described herein. The LiDAR system 600 includes a first laser 602a configured to produce a first laser signal Tx₁ having a first wavelength λ1 (e.g., 1530 nm). The first laser signal Tx₁ is provided to (e.g., fed into) a splitter 604a. The first laser signal Tx₁ is “chirped” such that the first laser frequency is changed with time over a frequency band BW1. In one example, the first laser frequency is changed at a first frequency rate α₁. The LiDAR system 600 includes a second laser 602b configured to produce a second laser signal Tx₂ having a second wavelength λ2 (e.g., 1550 nm). The second laser signal Tx₂ is fed into a splitter 604b. The second laser signal Tx₂ is “chirped” such that the second laser frequency is changed with time over a frequency band BW2. In one example, the second laser frequency is changed at a second frequency rate α₂. The frequency bands BW1 and BW2 may be non-overlapping. In some examples, BW1 and BW2 have values in the order of hundreds or thousands of GHz. In some examples, α₁ and α₂ have values in the order of 0.1-3 GHz/μs.

The splitter 604a provides a first split laser signal Tx_{1,1} generated from the first laser signal Tx₁ to a combiner 606 and a second split laser signal Tx_{1,2} generated from the first laser signal Tx₁ to a first mixer 614a. Likewise, the splitter 604b provides a first split laser signal Tx_{2,1} generated from the second laser signal Tx₂ to the combiner 606 and a second split laser signal Tx_{2,2} generated from the second laser signal Tx₂ to a second mixer 614b. The combiner 606 combines the first split laser signals Tx_{1,1} and Tx_{2,1} and provides the combined signal to a direction selective device 608, which provides (e.g., forwards) the combined signal to a scanner 610. The scanner 610 uses the combined signal to transmit light and receives light reflected by a target. In one example, the scanner 610 steers the laser signal over the FOV of the LiDAR system 600. In some examples, the scanner 610 includes at least one mirror configured to direct the laser signal in horizontal (e.g., x-axis) and vertical (e.g., y-axis) scan directions. In certain examples, portions of the LiDAR system 600 (including the scanner 608) can be rotated to steer the laser signal over the FOV. In other examples, the scanner 610 can include a diffraction element (e.g., a prism) that directs light based on frequency. For example, as the frequencies of the signals provided by the first laser 602a and/or the second laser 602b are adjusted, the diffraction element may direct the light in different scan directions (e.g., similar to a scan mirror).

The reflected light signal Rx is provided (e.g., passed back) to the direction selective device 608, which provides (e.g., forwards) the reflected light signal Rx to a splitter 612. The splitter 612 provides a first split reflected light signal Rx₁ generated from the reflected light signal Rx to the first mixer 614a and a second split reflected light signal Rx₂ from the reflected light signal Rx to the second mixer 614b. In some examples, the splitter 612 includes one or more filters (e.g., band-pass filters) or functions as a wavelength division demultiplexing device to separate the two laser wavelengths. In certain examples, one or more filters can be used in place of the splitter 612. At the first mixer 614a, the second split laser signal Tx_{1,2} may be used as a local oscillator (LO) signal and mixed with the first split reflected light signal Rx₁. The first mixer 614a may be configured to mix the first split reflected light signal Rx₁ with the local oscillator signal LO to generate a beat frequency fb₁. The mixed signal with the beat frequency fb₁ may be provided to a first differential photodetector 616a configured to produce a current based on the received light. In one example, the mixed signal is a single-ended signal; however, in other examples, the mixed signal can be a differential signal. The current may be converted to voltage by an amplifier (e.g., a first transimpedance amplifier (TIA)) 618a, which may be provided to (e.g., fed to) a first analog-to-digital converter (ADC) 620a configured to convert the analog signal (e.g., voltage) to digital samples for a first target detection module 622a.

At the second mixer 614b, the second split laser signal Tx_{2,2} may be used as a local oscillator (LO) signal and mixed with the second split reflected light signal Rx₂. The second mixer 614b may be configured to mix the second split reflected light signal Rx₂ with the local oscillator signal LO to generate a beat frequency fb₂. The mixed signal with the beat frequency fb₂ may be provided to a second differential photodetector 616b configured to produce a current based on the received light. In one example, the mixed signal is a single-ended signal; however, in other examples, the mixed signal can be a differential signal. The current may be converted to voltage by a second amplifier (e.g., transimpedance amplifier (TIA)) 618b, which may be and provided (e.g., fed) to a second analog-to-digital converter (ADC) 620b configured to convert the analog signal (e.g., voltage) to digital samples for a second target detection module 622b.

The target detection modules 622a, 622b may be configured to determine (e.g., calculate) the range and/or speed (or velocity) of the target based on the first digital sampled signal representing beat frequency fb₁ and the second digital sampled signal representing beat frequency fb₂, as described in greater detail below. In some examples, the target detection modules 622a, 622b are configured to generate a point cloud corresponding to the FOV of the scanner 610. In one example, each of the target detection modules 622a, 622b corresponds to one or more controllers (or processors). In some examples, the target detection modules 622a, 622b correspond to the same controller (or processor).

In some examples, if the laser frequencies are spaced far enough apart, the LiDAR system can be arranged to share common components between the first laser and the second laser. For example, common components may be shared if inter-modulation products between the two lasers are out-of-band (e.g., outside component bandwidths or frequency bands of interest to the system). In other words, the spacing between the laser wavelengths may be selected such that the beating between the two laser frequencies is outside the electrical bandwidth of the electrical circuit that processes the electrical signal generated from the mixed optical signal. In some embodiments, the electrical circuit consists of photodiodes (e.g., a differential photodetector), a transimpedance amplifier, and an ADC. In one example, the electrical bandwidth of the LiDAR system is approximately 2 GHz. In other examples, the electrical bandwidth may be any value between approximately 500 MHz and 5 GHz.

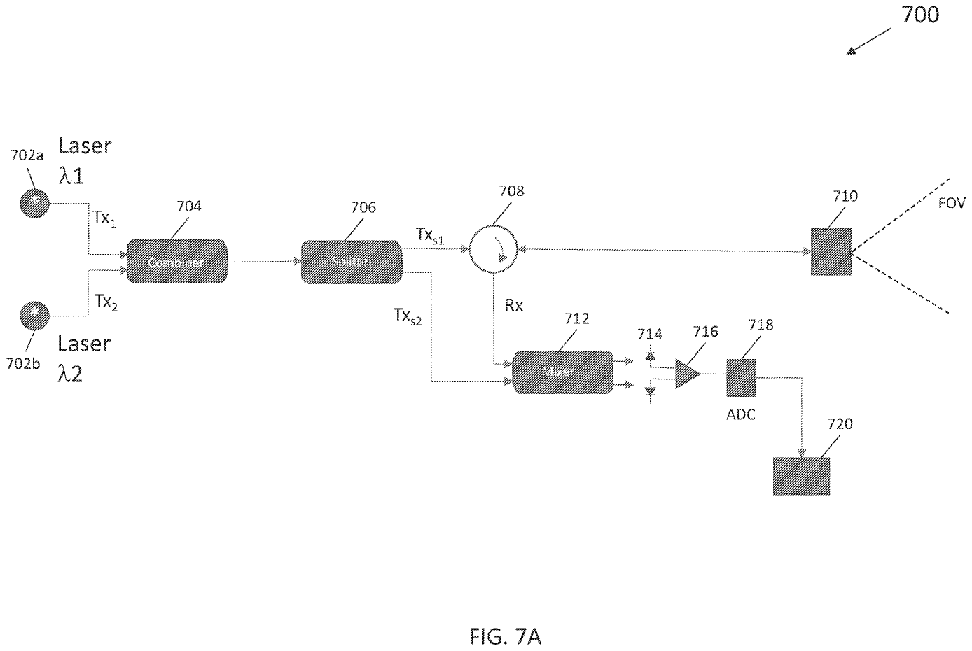

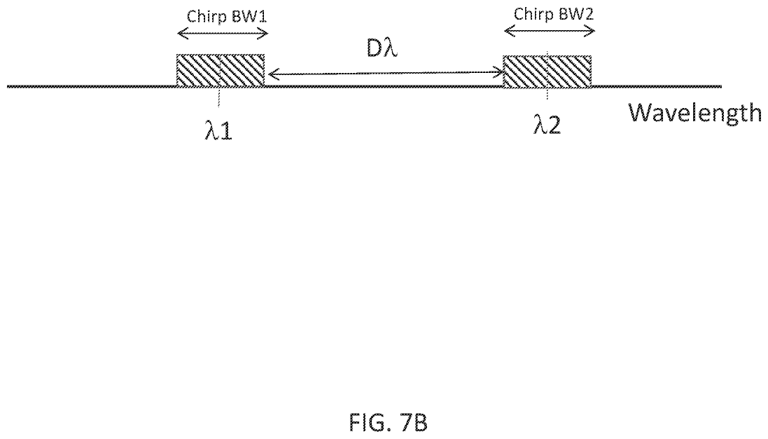

FIG. 7A illustrates an FMCW coherent LiDAR system 700 configured to determine the range and/or speed (or velocity) of a target. In one example, the system 700 includes one or more components shared between the multiple lasers. The LiDAR system 700 includes a first laser 702a configured to produce a first laser signal Tx₁ having a first wavelength λ1 (e.g., 1530 nm). The first laser signal Tx₁ is “chirped” such that the first laser frequency is changed with time over a frequency band. In one example, the first laser frequency is changed at a first frequency rate α₁. The LiDAR system 700 includes a second laser 702b configured to produce a second laser signal Tx₂ having a second wavelength λ2 (e.g., 1550 nm). The second laser signal Tx₂ is “chirped” such that the second laser frequency is changed with time over a frequency band. In one example, the second laser frequency is changed at a second frequency rate α₂.

A combiner 704 combines the first laser signal Tx₁ and the second laser signal Tx₂ and provides the combined signal to a splitter 706. The splitter 706 provides a first split laser signal Txₛ₁ generated from the combined signal to direction selective device 708, which provides (e.g., forwards) the first split laser signal Txₛ₁ to a scanner 710. Likewise, the splitter 706 provides a second split laser signal Txₛ₂ to a mixer 712. The scanner 710 uses the first split laser signal Txₛ₁ to transmit light and receives light reflected by a target. The scanner 710 may be similar to the scanner 610 of FIG. 6. The reflected light signal Rx is provided (e.g., passed back) to the direction selective device 708, which provides (e.g., forwards) the reflected light signal Rx to the mixer 712.

At the mixer 712, the second split laser signal Txₛ₂ is used as a local oscillator (LO) signal and mixed with the reflected light signal Rx. The mixer 712 may be configured to mix the reflected light signal Rx with the local oscillator signal LO. The mixer 712 may provide the mixed optical signal to differential photodetector 714, which may generate an electrical signal representing a first beat frequency fb₁ of the mixed optical signals corresponding to the wavelength λ1 of the first laser 702a and a second beat frequency fb₂ of the mixed optical signals corresponding to the wavelength λ2 of the second laser 702b. In one example, the first beat frequency f_{b1}=|f_{Tx1}−f₁(Rx)| and the second beat frequency f_{b2}=|f_{Tx2}−f₂(Rx)| (the absolute values of the differences between the proximate frequency components of the mixed optical signal). In some embodiments, the current produced by the differential photodetector 714 based on the mixed light may have frequency components at the first and second beat frequencies. In one example, the signal generated by the photodetector 714 is a single-ended signal; however, in other examples, the signal generated by the photodetector 714 can be a differential signal. The photodetector current may be converted to voltage by an amplifier (e.g., a transimpedance amplifier (TIA)) 716, and this voltage may be provided (e.g., fed) to an analog-to-digital converter (ADC) 718 configured to convert the analog signal to digital samples for a target detection module 720. The target detection module 720 may be configured to determine (e.g., calculate) the radial velocity of the target based on the digital sampled signal with beat frequencies fb₁ and fb₂.

The target detection module 720 is configured to determine (e.g., calculate) the range and/or speed (or velocity) of the target based on the digital sampled signal with beat frequencies fb₁, fb₂, as described in greater detail below. In some examples, the target detection stage 720 is configured to generate a point cloud corresponding to the FOV of the scanner 710. In one example, the target detection module 720 corresponds to one or more controllers (or processors).

FIG. 7B illustrates a laser wavelength scheme that can be used with the LiDAR system 700 of FIG. 7A. In one example, the first laser wavelength λ1 corresponds to the wavelength of the first laser 702a and the second laser wavelength λ2 corresponds to the wavelength of the second laser 702b. As shown, a wavelength distance Dλ is provided based on the spacing of the wavelengths λ1, λ2. As described above, the lasers 702a, 702b can be chirped over wavelength (or frequency) to calculate range and/or speed (or velocity) of the target. In some examples, the wavelength distance Dλ corresponds to the spacing between an upper edge of a first bandwidth BW1 associated with a chirp of the first laser 702a and a lower edge of a second bandwidth BW2 associated with a chirp of the second laser 702b. The bandwidths BW1, BW2 may have the same size or may be configured differently.

The spacing between the laser wavelengths (e.g., Dλ) may be selected such that the beat frequency (or frequencies) between the two laser wavelengths λ1, λ2 is outside the electrical bandwidth of the electrical circuit that processes the electrical signal generated from the mixed optical signal. In one embodiment, the electrical circuit consists of the differential photodetector 714, the transimpedance amplifier 716, and the ADC 718. The spacing Dλ can be selected such that the two lasers 702a, 702b do not interact with each other directly. In one example, the following relationship can be used to select the spacing Dλ:

$$\vert D λ ( \frac{c}{{λ}^{2}} ) \vert ≫ {BW}_{s y s}$$

where c is the speed of light, λ is the wavelength λ1 of the first laser 702a or the wavelength λ2 of the second laser 702b, and BW_{sys} is the electrical bandwidth of the LiDAR system 700 (e.g., bandwidth of the electrical circuit components included in the system).

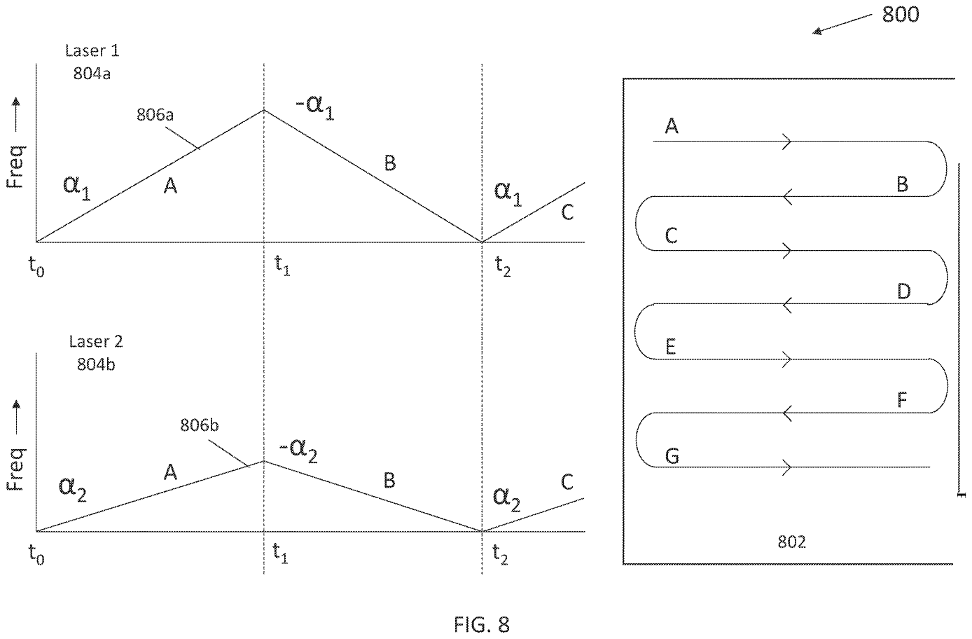

FIG. 8 illustrates a method 800 for operating an FMCW coherent LiDAR system in accordance with aspects described herein. In one example, the method 800 can be used to operate the LiDAR system 600 of FIG. 6 and/or the LiDAR system 700 of FIG. 7. In the example of FIG. 8, the method 800 involves the use of a scan pattern 802 for generating a target point cloud. In some examples, the scan pattern 802 corresponds to the scan direction of the scanner 610 (or the scanner 710). In the illustrated example, the scan pattern 802 includes scanning horizontally from left-to-right along a first row A, from right-to-left along a second row B, from left-to-right along a third row C, and so on.

A first graph 804a illustrates a frequency chirp as a function of time for a first laser signal (e.g., first laser 602a, 702a), depicted as solid line 806a. Likewise, a second graph 804b illustrates a frequency chirp as a function of time for a second laser signal (e.g., second laser 602b, 702b), depicted as solid line 806b. Rather than using chirps having a positive slope and a negative slope to generate each point of the point cloud, the chirps are configured with a unidirectional slope across each horizontal row of the scan pattern 802. For example, the LiDAR system may scan along row A of the scan pattern 802 from time t₀ to time t₁. During this first time period, the first laser provides a chirp 806a having a positive slope that increases in frequency at the first frequency rate α₁. During the same time period, the second laser provides a chirp 806b having a positive slope that increases in frequency at the second frequency rate α₂. In one example, the values of the first frequency rate α₁ and the second frequency rate α₂ are between approximately 0.1-3 GHz/μs. Once the LiDAR system has completed the scan across row A, the system may scan along row B from time t₁ to time t₂. During this second time period, the first laser may provide a chirp 806a having a negative slope that decreases in frequency at the first frequency rate −α₁. During the same time period, the second laser provides a chirp 806b having a negative slope that decreases in frequency at the second frequency rate −α₂. For the third scan across row C, the first and second lasers can return to providing chirps with positive slopes, and the process can repeat until the scan pattern 802 is completed. Being that the chirps are configured with a unidirectional slope across each horizontal row of the scan pattern 802, the scan rate of the LiDAR system is not limited by the chirp patten. In other words, the LiDAR system does not have to wait for a particular chirp pattern to complete (e.g., slope up, slope down) before moving on to the next target point in the row.

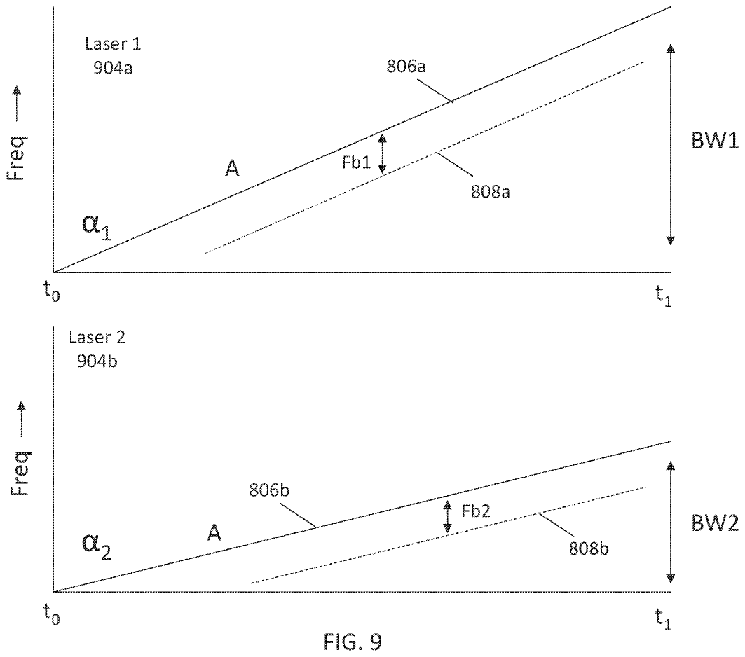

FIG. 9 includes a first graph 904a representing a portion of the first chirp 806a provided by the first laser and a second graph 904b representing a portion of the second chirp 806b provided by the second laser. As shown, the portions of the chirps 806a, 806b correspond to the first time period from time t₀ to time t₁ while the LiDAR system is scanning along row A of the scan pattern 802. In one example, the first frequency rate α₁ is greater than the second frequency rate α₂. As such, the frequency of the first chirp 806a increases at a faster rate than the frequency of the second chirp 806b. In some examples, being that the first frequency rate α₁ is greater than the second frequency rate α₂, the bandwidth BW1 of the first chirp 806a is larger than the bandwidth BW2 of the second chirp 806b.

The first graph 904a includes a first reflected signal 808a corresponding to the chirp 806a and the second graph 904b includes a second reflected signal 808b corresponding to the chirp 806b. It should be appreciated that the reflected signals 808a, 808b can be received by the LiDAR system as a combined signal. In some examples, the combined signal is split into the reflected signals 808a, 808b via a splitter and/or one or more filters. As described above, the first reflected signal 808a can be mixed with a local oscillator signal LO (e.g., the first chirp 806a) to produce a first mixed signal representing a first beat frequency f_{b1}. Likewise, the second reflected signal 808b can be mixed with a local oscillator signal LO (e.g., the second chirp 806b) to produce a second mixed signal representing a second beat frequency f_{b2}. As shown, the first beat frequency f_{b1} may represent a difference between the first chirp 806a and the first received signal 808a and the second beat frequency f_{b2} may represent a difference between the second chirp 806b and the second received signal 808b.

Once recovered, the beat frequencies f_{b1}, f_{b2} can be used to generate a point cloud by determining the range (and, optionally, speed or velocity) of the target. In some examples, the relationship between the beat frequencies, the range, and the velocity of the target corresponds to the slope of the chirps 806a, 806b. For example, in the positive slope case illustrated in FIG. 9, the following relationships can be used to determine the range and velocity of the target:

$${f}_{b 1} = τ {α}_{1} - {f}_{d} {f}_{b 2} = τ {α}_{2} - {f}_{d}$$

where τ is the time of flight related to the range (R) to the target (e.g., τ=2R/c) and f_{d} is the Doppler frequency shift due to the radial velocity of the target. In one example, the relationships above assume that the frequency rates α₁, α₂ are greater than zero. Given that the beat frequencies f_{b1}, f_{b2} and the frequency rates α₁, α₂ are known, the system of equations can be solved to provide the following relationships:

$$τ = \frac{( {f}_{b 1} - {f}_{b 2} )}{( {α}_{1} - {α}_{2} )} \\ {f}_{d} = \frac{( {f}_{b 2} - \frac{{α}_{1}}{{α}_{2}} {f}_{b 2} )}{( \frac{{α}_{1}}{{α}_{2}} - 1 )}$$

where τ is the time of flight related to the range to the target and f_{d} is the Doppler frequency shift due to the radial velocity of the target. As described above, the Doppler frequency can be used to calculate the velocity of the target. As such, the relationships above can be used to generate three-dimensional points for the point cloud while the chirps 806a, 806b have positive slopes (e.g., scan of Row A, scan of Row C, etc.).

For the negative slope case of the chirps 806a, 806b (e.g., scan of Row B), the following relationships can be used to determine the range and velocity of the target:

$${f}_{b 1} = τ {α}_{1} + {f}_{d} {f}_{b 2} = τ {α}_{2} + {f}_{d}$$

where τ is the time of flight related to the range to the target and f_{d} is the Doppler frequency shift due to the radial velocity of the target. Given that the beat frequencies f_{b1}, f_{b2} and the frequency rates α₁, α₂ are known, the system of equations can be solved to determine the range (and, optionally, speed or velocity) of the target. As such, the relationships above can be used to generate three-dimensional points for the point cloud while the chirps 806a, 806b have negative slopes.

While the examples above describe operating the LiDAR systems 600, 700 with first and second lasers configured to provide chirps 806a, 806b with the same slope direction, it should be appreciated that the chirps 806a, 806b can be configured differently.

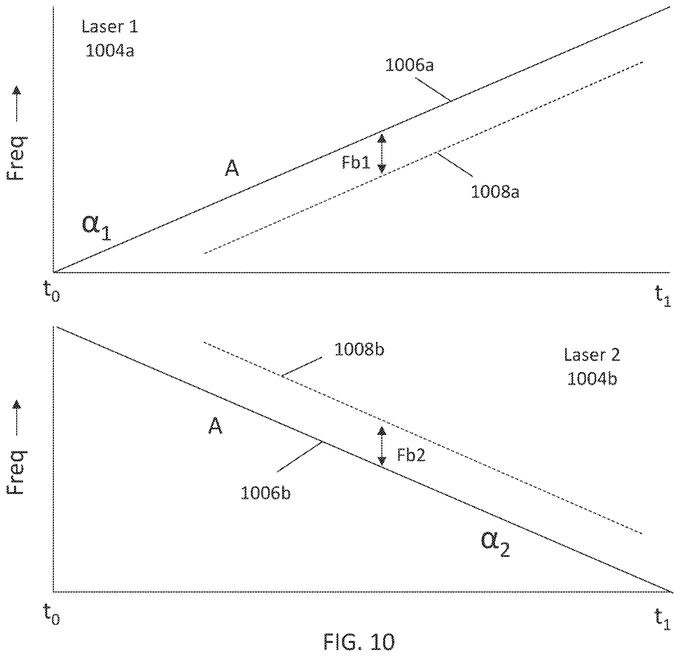

FIG. 10 includes a first graph 1004a representing a portion of a first chirp 1006a provided by the first laser and a second graph 1004b representing a portion of the second chirp 1006b provided by the second laser. As shown, the portions of the chirps 1006a, 1006b correspond to the first time period from time t₀ to time t₁ while the LiDAR system is scanning along row A of the scan pattern 802. In one example, the first frequency rate α₁ is substantially the same as the second frequency rate α₂, except the first frequency rate α₁ and the second frequency rate α₂ have opposite signs. As such, the frequency of the first chirp 1006a increases over the first period and the frequency of the second chirp 1006b decreases over the first time period at the same rate. In some examples, the bandwidth of the first chirp 1006a is substantially the same as bandwidth of the second chirp 1006b.

The first graph 1004a includes a first reflected signal 1008a corresponding to the chirp 1006a and the second graph 1004b includes a second reflected signal 1008b corresponding to the chirp 1006b. It should be appreciated that the reflected signals 1008a, 1008b can be received by the LiDAR system as a combined signal. In some examples, the combined signal is split into the reflected signals 1008a, 1008b via a splitter and/or one or more filters. As described above, the first reflected signal 1008a can be mixed with a local oscillator signal LO (e.g., the first chirp 1006a) to produce a first mixed signal representing a first beat frequency f_{b1}. Likewise, the second reflected signal 1008b can be mixed with a local oscillator signal LO (e.g., the second chirp 1006b) to produce a second mixed signal representing a second beat frequency f_{b2}. As shown, the first beat frequency f_{b1} may represent a difference between the first chirp 1006a and the first received signal 1008a and the second beat frequency f_{b2} may represent a difference between the second chirp 1006b and the second received signal 1008b.

Once recovered, the beat frequencies f_{b1}, f_{b2} can be used to generate a point cloud by determining the range (and, optionally, speed or velocity) of the target. For example, in the case illustrated in FIG. 10, the following relationships can be used to determine the range and velocity of the target:

$${f}_{b 1} = τ {α}_{1} - {f}_{d} {f}_{b 2} = τ {α}_{2} + {f}_{d}$$

where τ is the time of flight related to the range to the target and f_{d} is the Doppler frequency shift due to the radial velocity of the target. In one example, the relationships above assume that the frequency rates α₁, α₂ are non-zero. Given that the beat frequencies f_{b1}, f_{b2} and the frequency rates α₁, α₂ are known, the system of equations can be solved to provide the following relationships:

$$τ = \frac{( {f}_{b 1} + {f}_{b 2} )}{( {α}_{1} + {α}_{2} )} \\ {f}_{d} = \frac{( \frac{{α}_{1}}{{α}_{2}} {f}_{b 2} - {f}_{b 1} )}{( \frac{{α}_{1}}{{α}_{2}} + 1 )}$$

where τ is the time of flight related to the range to the target and f_{d} is the Doppler frequency shift due to the radial velocity of the target. As described above, the Doppler frequency can be used to calculate the velocity (or speed) of the target. As such, the relationships above can be used to generate three-dimensional points for the point cloud.

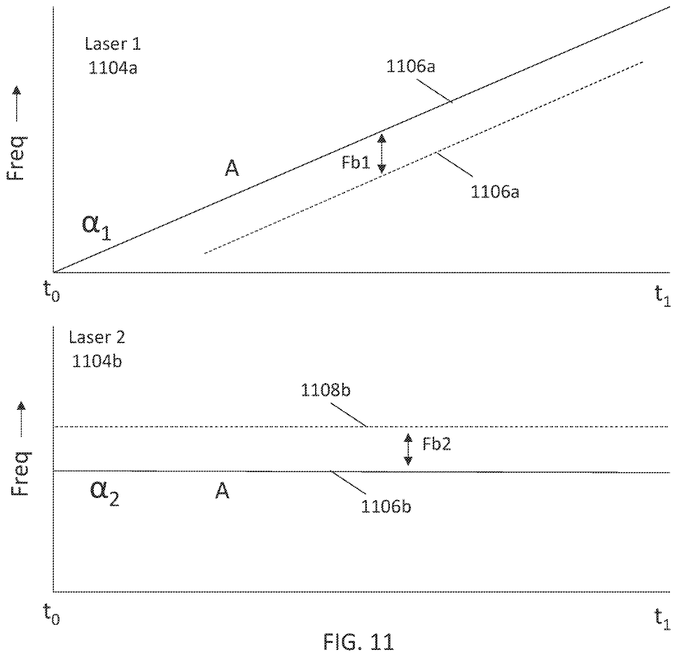

FIG. 11 includes a first graph 1104a representing a portion of a first chirp 1106a provided by the first laser and a second graph 1104b representing a portion of the second chirp 1106b provided by the second laser. As shown, the portions of the chirps 1106a, 1106b correspond to the first time period from time t₀ to time t₁ while the LiDAR system is scanning along row A of the scan pattern 802. In one example, the first frequency rate α₁ is greater than zero and the second frequency rate α₂ is zero. As such, the frequency of the first chirp 1106a increases over the first period and the frequency of the second chirp 1106b remains substantially constant. In other examples, the first frequency rate α₁ may be zero and the second frequency rate α₂ may be greater than zero.

The first graph 1104a includes a first reflected signal 1108a corresponding to the chirp 1106a and the second graph 1104b includes a second reflected signal 1108b corresponding to the chirp 1106b. It should be appreciated that the reflected signals 1108a, 1108b can be received by the LiDAR system as a combined signal. In some examples, the combined signal is split into the reflected signals 1108a, 1108b via a splitter and/or one or more filters. As described above, the first reflected signal 1108a can be mixed with a local oscillator signal LO (e.g., the first chirp 1106a) to produce a first mixed signal representing a first beat frequency f_{b1}. Likewise, the second reflected signal 1108b can be mixed with a local oscillator signal LO (e.g., the second chirp 1106b) to produce a second mixed signal representing a second beat frequency f_{b2}. As shown, the first beat frequency f_{b1} may represent a difference between the first chirp 1106a and the first received signal 1108a and the second beat frequency f_{b2} may represent a difference between the second chirp 1106b and the second received signal 1108b.

Once recovered, the beat frequencies f_{b1}, f_{b2} can be used to generate a point cloud by determining the range (and, optionally, speed or velocity) of the target. For example, in the case illustrated in FIG. 11, the following relationships can be used to determine the range and velocity of the target:

$$τ = \frac{( {f}_{b 1} + {f}_{d} )}{{α}_{1}} {f}_{d} = {f}_{b 2}$$

where τ is the time of flight related to the range to the target and f_{d} is the Doppler frequency shift due to the radial velocity of the target. As described above, the Doppler frequency shift can be used to calculate the velocity (or speed) of the target. As such, the relationships above can be used to generate three-dimensional points for the point cloud.

In one example, being that the second frequency rate α₂ is zero, the sign of the Doppler frequency may be undetectable using a non-phase diversity receiver (e.g., LiDAR systems 600, 700). As such, a LiDAR system having a phase diversity receiver may be used with the chirp scheme of FIG. 11 to recover the sign (i.e., direction) of the Doppler frequency.

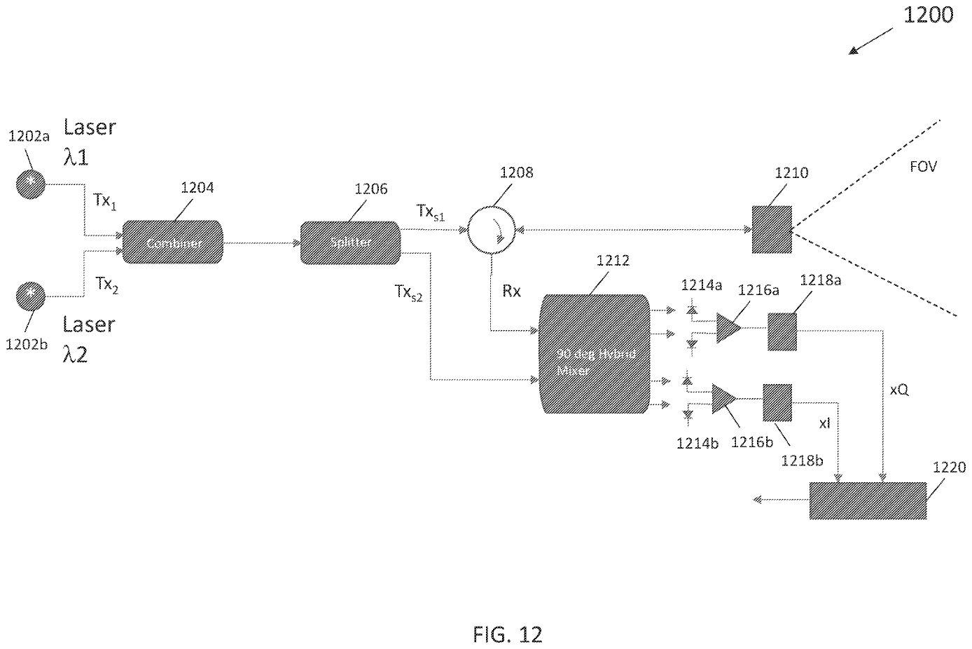

FIG. 12 illustrates an FMCW coherent LiDAR system 1200 configured to determine the range and/or speed of a target. In one example, the LiDAR system 1200 includes a phase diversity receiver. In some examples, the LiDAR system 1200 can operate with the chirp scheme illustrated in FIG. 11. The LiDAR system 1200 includes a first laser 1202a configured to produce a first laser signal Tx₁ having a first wavelength λ1 (e.g., 1530 nm). The first laser signal Tx₁ is “chirped” such that the first laser frequency is changed with time over a frequency band. In one example, the first laser frequency is changed at a first frequency rate α₁. The LiDAR system 1200 includes a second laser 1202b configured to produce a second laser signal Tx₂ having a second wavelength λ2 (e.g., 1550 nm). The second laser signal Tx₂ has a substantially constant laser frequency.

A combiner 1204 combines the first laser signal Tx₁ and the second laser signal Tx₂ and provides the combined signal to a splitter 1206. The splitter 1206 provides a first split laser signal TXₛ₁ from the combined signal to a direction selective device 1208, which forwards the first split laser signal Txₛ₁ to a scanner 1210. Likewise, the splitter 1206 provides a second split laser signal TXₛ₂ to a mixer 1212. In one example, the mixer 1212 is a 90 deg hybrid mixer. The scanner 1210 uses the first split laser signal Txₛ₁ to transmit light and receives light reflected by a target. The reflected light signal Rx is passed back to the direction selective device 1208, which provides (e.g., forwards) the reflected signal Rx to the mixer 1212.

At the mixer 1212, the second split laser signal TXₛ₂ is used as a local oscillator (LO) signal and mixed with the reflected signal Rx. The mixer 1212 is configured to mix the reflected signal Rx with the local oscillator signal LO. The mixer 1212 provides an in-phase (I) mixed optical signal to a first differential photodetector 1214a, which may generate an electrical signal representing a first beat frequency f_{b1} and a second beat frequency f_{b2} of the in-phase mixed optical signal. In one example, the first beat frequency f_{b1}=|f_{Tx1}−f_{1Rx}| and the second beat frequency f_{b2}=|f_{Tx2}−f_{2Rx}| (the absolute value of the difference between the proximate frequency components of the in-phase mixed optical signals). In some embodiments, a first current produced by the first differential photodetector 1214a based on the mixed light may have frequency components at the beat frequencies f_{b1}, f_{b2}. The first current is converted to voltage by a first amplifier (e.g., transimpedance amplifier (TIA)) 1216a, and this voltage is provided (e.g., fed) to a first analog-to-digital converter (ADC) 1218a configured to convert the analog signal to digital samples for a target detection module 1220. Likewise, the mixer 1212 provides a 90 deg out-of-phase (Q) mixed optical signal to a second differential photodetector 1214b, which may generate an electrical signal representing the beat frequencies f_{b1}, f_{b2}. In some embodiments, a second current produced by the second differential photodetector 1214b based on the mixed light may have frequency components at the beat frequencies f_{b1}, f_{b2}. The second current is converted to voltage by a second amplifier (e.g., TIA) 1216b, and this voltage is provided (e.g., fed) to a second ADC 1218b configured to convert the analog signal to digital samples for the target detection module 1220.

The target detection module 1220 may be configured to generate the range and/or speed of the target based on the digital sampled signals with beat frequencies f_{b1}, f_{b2}, as described above. In one example, a DFT is performed using the digital sampled signals. The sign (e.g., positive or negative) of the beat frequencies f_{b1}, f_{b2} may be used to determine the direction of the target Doppler shift. For example, a negative frequency may indicate that the target is moving away from the LiDAR system 1200. Likewise, a positive frequency may indicate that the target is moving towards the LiDAR system 1200. In one example, the signs of both beat frequencies f_{b1}, f_{b2} are used to determine the Doppler shift direction; however, in other examples, the Doppler shift direction may be determined from a single beat frequency (e.g., f_{b1} or f_{b2}). In some examples, the target detection module 1220 is configured to generate a point cloud corresponding to the FOV of the scanner 1210. In one example, the target detection module 1220 corresponds to one or more controllers (or processors).

### Some Examples of Beam Steering Techniques

As described above, LiDAR systems can include one or more scanners (e.g., scanner 308, 408, 510, 710, 1210) configured to steer the laser signal(s) over the FOV of the LiDAR system. In some examples, the scanner includes at least one mirror configured to direct the laser signal(s) in horizontal (e.g., x-axis) and/or vertical (e.g., y-axis) scan directions. In other examples, portions of the LiDAR system (including the scanner) can be rotated to steer the laser signal(s) over the FOV. The position and/or orientation of the scanner (or scanning mirror) may be dynamically adjusted in accordance with a scan pattern (e.g., scan pattern 802). The position and/or orientation of the scanner, scanning mirror, or LiDAR system may be adjusted using, for example, one or more mechanical actuators, MEMS, or motor assemblies. In other examples, the position of the scanning mirror can be adjusted using one or more flexure components. For example, the scanning mirror can be included in a scanning mirror mechanism that includes magnets, coils, structures, position/rotation sensors, and flexures. The flexure can be made of thin metal or a bundle of wires (e.g., parallel wires) (e.g., non-twisted parallel wires), which is structurally fixed at two ends and allowed to twist with the scanning mirror and the mirror mechanisms. Examples of mechanisms and techniques to control the position of the scanning mirror are described in U.S. patent application Ser. No. 17/392,080, titled “Scanning Mirror Mechanisms for LIDAR Systems, and Related Methods and Apparatus” and filed under Attorney Docket No. VLI-047CP on Aug. 2, 2021.

However, the use of mechanical steering components (e.g., actuators, motors, flexures, etc.) can increase the size and cost of LiDAR systems. In some examples, the scan rate and/or range of the LiDAR system may be limited by the steering/rotation provided by these mechanical steering components. In addition, such mechanical components may be prone to failures over time due to regular wear and tear. As such, the size, cost, and/or performance of LiDAR systems may be improved by the use of solid-state beam steering techniques.

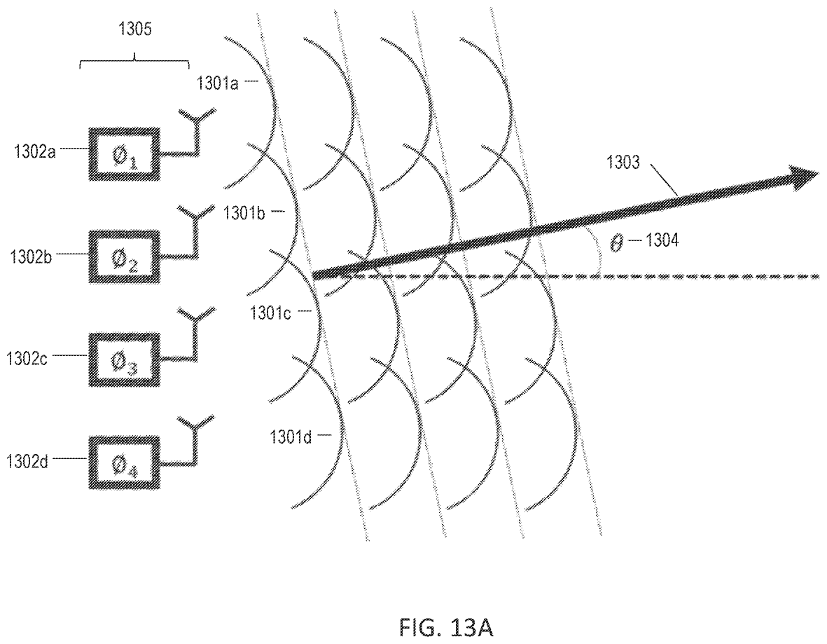

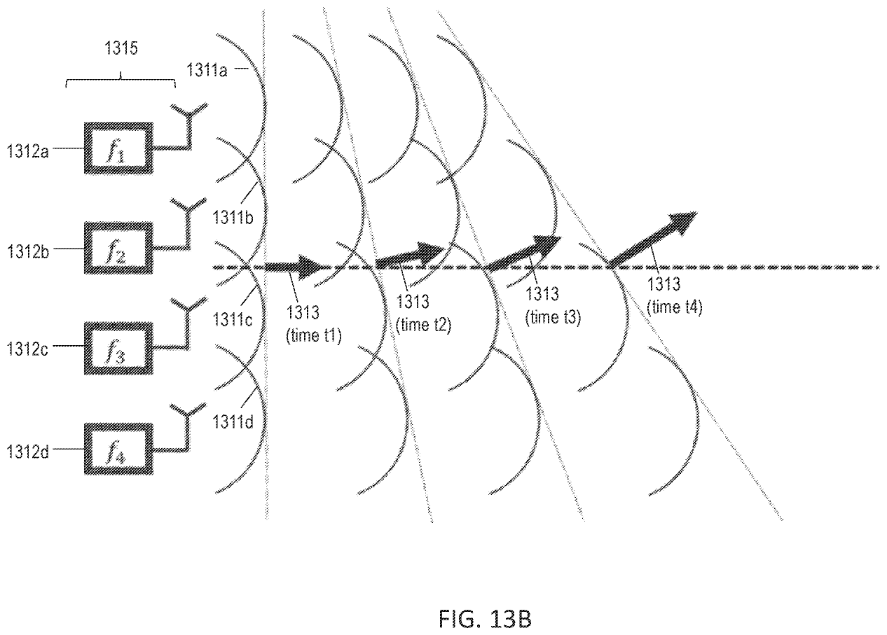

FIG. 13A illustrates an example solid-state beam steering technique which depends on a phase-arrayed structure. In this arrangement, light waves 1301 having substantially the same frequency but different phases φ emitted from different sources 1302 interfere together to generate an optical beam 1303 steered at a specific angle 1304. The angle of the beam is perpendicular to the phase-front of the waves (the plane where all the sources have the same phase). Because of the relative phase-shift between sources the phase-front is tilted in general. To steer the angle of the beam, the phase of each element 1302 of the phased-array 1305 is modulated. Therefore, the beam steering speed is dependent on the speed of the phase-modulating technology. Such technologies are generally not adequate to modulate at speed that can offer response time in the nanosecond or picosecond range. In addition, to achieve beam steering at angle 1304, the spacing between adjacent sources 1302 may be less than half of the wavelength of the light waves 1301. It may be difficult to implement such spacing in higher frequency applications (e.g. at optical wavelengths). As such, the technique illustrated in FIG. 13A is typically used to provide beam steering in the radio-frequency (RF) domain and is not suitable for many applications in the optical (or light) domain.

FIG. 13B illustrates an example solid-state beam steering technique which depends on a frequency-arrayed structure. In this arrangement, light waves 1311 having different frequencies f emitted from different sources 1312 interfere together to generate an optical beam 1313 that changes direction as it propagates. The distance between phase-fronts is different for the waves 1311 emitted by different array elements 1312 due to the waves 1311 emitted by different array elements 1312 having different frequencies f (or wavelengths λ). As the individual waves 1311 interfere to produce a combined wave (beam 1313), this phenomenon causes the direction of the phase-front of the combined wave to change with time. As a consequence, the direction of light beam changes spontaneously without the need of external modulation, and the steering speed is dependent on the difference between the frequencies of the waves 1311 and the spatial separation between the elements 1312 of the frequency-diversity array 1315.

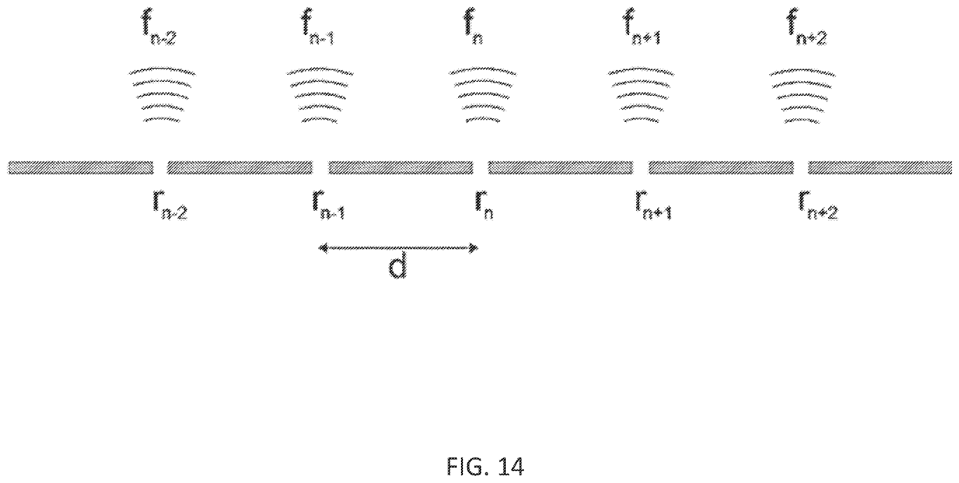

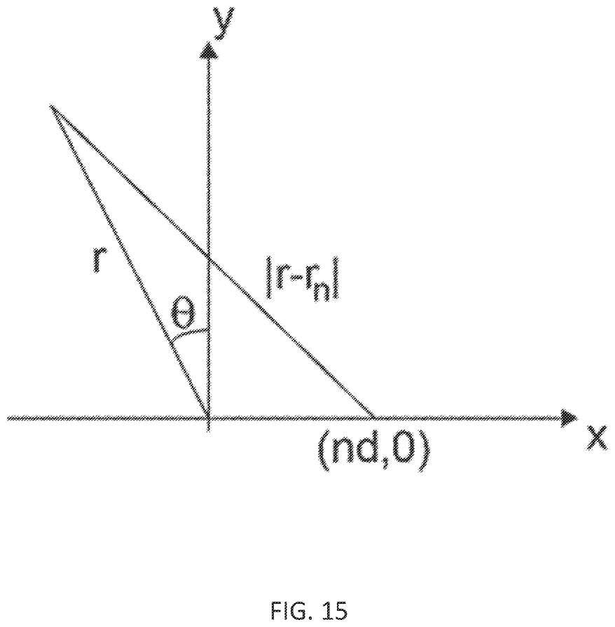

In some examples, a linear array of frequency combs (which is a set of phase-locked sources of different frequencies) is used, wherein each of the frequency combs acts as a cylindrical source of waves generated from an array of sources as shown in FIG. 14. These sources are placed at discrete locations with separation d, wherein each two consecutive (e.g., physically adjacent) sources have a change in frequency Δf where Δf=fₙ₊₁−fn. The coordinate system used in the mathematical formulation is shown in FIG. 15. The far field generated from this array takes the form of equation (1) below:

$$E = {\sum }_{n}^{N} = - N \frac{{e}^{i ( {ω}_{n} t - {k}_{n} \vert r - {r}_{n} \vert )}}{\sqrt{\vert r - {r}_{n} \vert}} \qquad ( 1 )$$

where rₙ=(xₙ, yₙ)=(nd, 0) is the coordinate location of the n^{th} source (shown in FIG. 15), ωₙ=ωₒ+nΔω is the angular frequency of the n^{th} source,

$${k}_{n} = \frac{{ω}_{n}}{c} = {k}_{o} + n Δ k$$

is the wavenumber of the n^{th} source, ωₒ is the angular frequency of the central source, kₒ is the wavenumber of the central source, Δω is the change in angular frequency, and Δk is the change in wavenumbers between two consecutive sources.

Using the following approximations:

$$Δ f << {f}_{0} , Δ ω << {ω}_{0} , Δ k << {k}_{0} ,$$

and
Nd<<r, and by substituting |r−rₙ|=\sqrt{(r sin θ+nd)²+r² cos²θ}≈r+nd sin θ, the following can be obtained:

$$E \approx \frac{1}{\sqrt{r}} {\sum }_{n = - N}^{N} {e}^{i ( {ω}_{n} t - {k}_{n} ( r + ndsin θ ) )} \approx \frac{{e}^{i ( {ω}_{o} t - {k}_{o} r )}}{\sqrt{r}} {\sum }_{n = - N}^{N} {e}^{in ( Δω t - Δ kr - {k}_{o} dsin θ )}$$

The summation on the right-hand side is a known summation in discrete signal processing.

If Ω=Δωt−Δkr−kₒd sin θ and using:

$${\sum }_{n = - N}^{N} {e}^{in Ω} = \frac{sin ( \frac{2 N + 1}{2} Ω )}{sin ( \frac{Ω}{2} )}$$

The following equation (2) can be obtained:

$$E \approx \frac{{e}^{i ( {ω}_{o} t - {k}_{o} r )}}{\sqrt{r}} \frac{sin ( \frac{2 N + 1}{2} Ω )}{sin ( \frac{Ω}{2} )} \qquad ( 2 )$$

This function has a maximum at Ω=0 and at integer multiples of 2π(Ω=2 πm). The value at which the summation is maximized corresponds to a rotating beam, and the Ω period of 2π corresponds to a beam steering repetition time of 1/Δf.

$$Ω = 0 leads to Δω t - Δ kr - {k}_{o} d sin θ = 0 ⇒ sin θ = ( \frac{Δω}{{k}_{o} d} ) t - ( \frac{Δ kr}{{k}_{o} d} )$$

The previous equation demonstrates the beam steering action through the time-variation of sin θ with respect to t. The term (Δkr/kₒd) is due to the time delay between the source and the distance of measurement r. The time frame can be defined such that sin θ=0 at t=0 by substituting t=t−(r/c). Therefore, the previous equation can be modified as equation (3) below:

$$sin θ = ( \frac{Δ ω}{{k}_{o} d} ) t \qquad ( 3 )$$

The value of λ₀ represents the center wavelength of the frequency comb (or the center source). In some examples, the separation d between sources is on the order of (0.1 to 1)λ₀, preferably on the order of 0.5λ₀. The frequency difference between adjacent sources can have a wide range of variability ranging from, for example, a few tens of Hz to a few MHz.

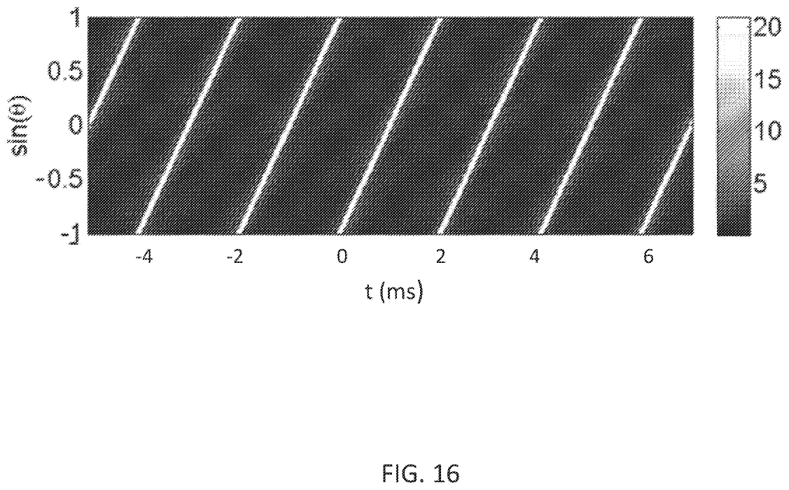

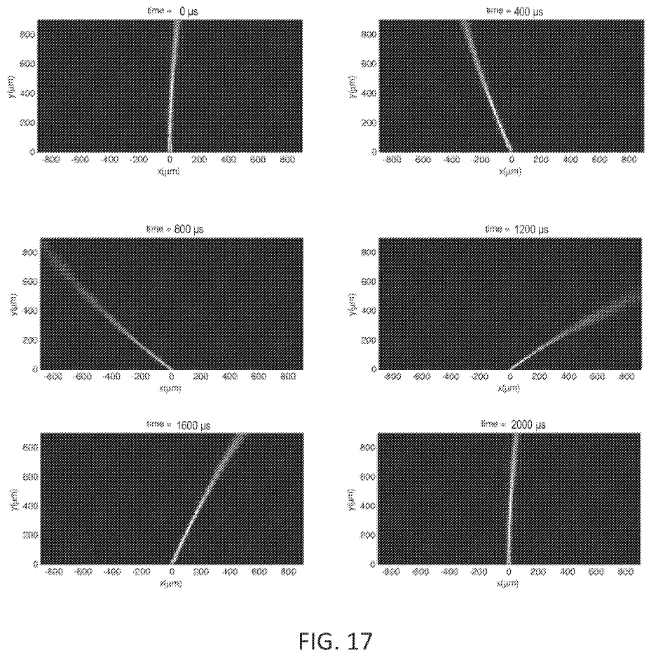

FIG. 16 illustrates a plot of the intensity I=|E|² with respect to sin θ and t, where E is calculated according to equation (2). The plot explains the beam steering effect, and also demonstrates periodicity patterns in time. In the illustrated plot, λ₀=1.5 μm, d=750 nm, Δf=500 Hz, with 41 frequency comb lines (2N+1=41) in equation (1).

The periodicity of 2π with respect to Ω imposes a temporal periodicity τ where:

$$Δωτ = 2 π$$

hence, equation (4) below:

$$τ = \frac{2 π}{Δ ω} = \frac{1}{Δ f} \qquad ( 4 )$$

Equation (4) implies that the period of the beam steering is the inverse of the frequency separation between the sources. In addition, the period of 2π in Ω may cause multiple values of θ corresponding to multiple beams. A single beam is guaranteed only when a single value of sin θ lies in the interval [−1,1], which requires:

$$2 {k}_{o} d < 2 π$$

or, equation (5) below:

$$d < \frac{{λ}_{0}}{2} \qquad ( 5 )$$

The inequality of equation (5) implies that to have a single beam, a separation is needed between the sources that does not exceed half the wavelength of the central source.

FIG. 17 illustrates simulation results of light intensity at various time instants calculated according to equation (1). Beam steering action is obtained from a frequency-arrayed source arrangement including 41 elements. In the illustrated plot, λ₀=1.5 μm, d=750 nm, Δf=500 Hz, with 41 frequency comb lines (2N+1=41). The period of steering is 2 ms in accordance with equation (4).

In some examples, an ultrashort laser source is used to provide the phase-locked spectral components of the frequency comb. Any combination of 1) a conventional diffraction grating generating diffracted beams; 2) a lens for receiving diffracted beams and focusing the same onto a focal plane; 3) a metasurface that is configured to provide the grating function; 4) a metasurface that is configured to provide the lens function; and 5) Silicon Photonics waveguides and gratings may be used to implement the frequency-arrayed solid-state beam steering technique described above.

### Solid-State FMCW Coherent LiDAR Devices

As described above, FMCW coherent LiDAR devices can provide safer operating conditions as well as improved measurement sensitivity and interference immunity. There is a particular need for the benefits of FMCW coherent LiDAR devices in a variety of systems and applications that rely on the types of measurements collected by LiDAR devices, including autonomous vehicles, advanced driver assistance systems, unmanned aerial vehicles (e.g., drones), spacecrafts, airborne obstacle detection (e.g., obstacle detection systems for aircraft), automated warehouse technology (e.g., systems that automate the processes of moving inventory into, within, and/or out of warehouses), smart road technology, mapping, surveying, robotics, augmented reality applications, virtual reality applications, mixed reality applications, identification (e.g., face ID) imaging, and security and threat detection systems.

One obstacle to the widespread adoption of FMCW coherent LiDAR devices has been the absence of solid-state beam steering techniques that are suitable for FMCW coherent LiDAR and can be implemented using photonic integrated circuit (“PIC”) technologies (e.g., silicon photonic chips). Such beam steering techniques are needed to reduce the size and cost of FMCW coherent LiDAR devices and to enhance their performance (e.g., mitigate doppler broadening induced by moving scanning mirrors, enhance reliability, etc.).

Accordingly, improved FMCW coherent LiDAR systems with solid-state beam steering are described herein. In at least one embodiment, a LiDAR system includes at least one laser configured to provide at least one frequency chirp to determine the range and/or speed (or velocity) of a target. In one example, the at least one frequency chirp is provided to a plurality of optical emitters with different time delays to provide solid-state beam steering over the FOV of the LiDAR system. In some examples, the LiDAR system is implemented using silicon photonic (SiP) technologies.

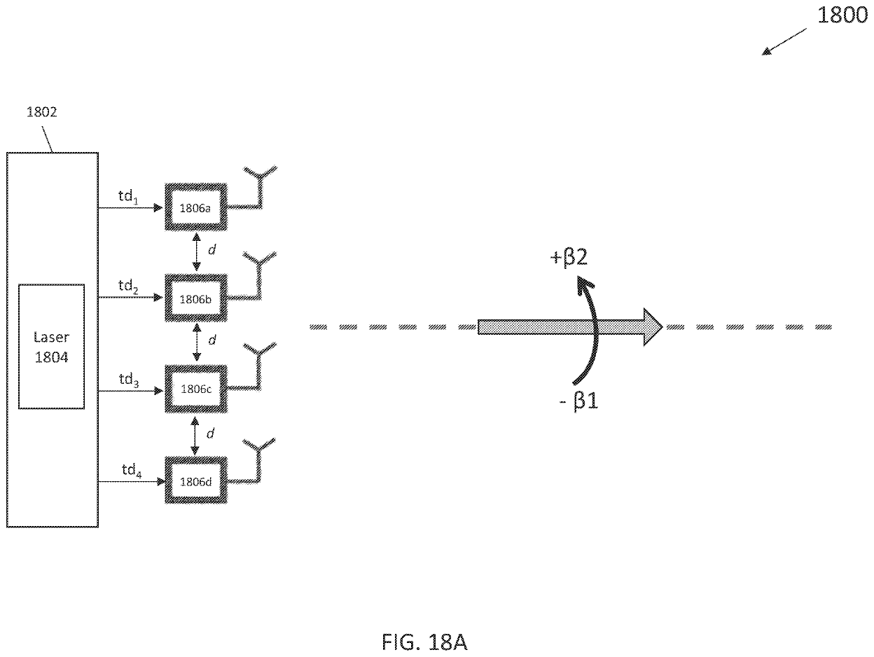

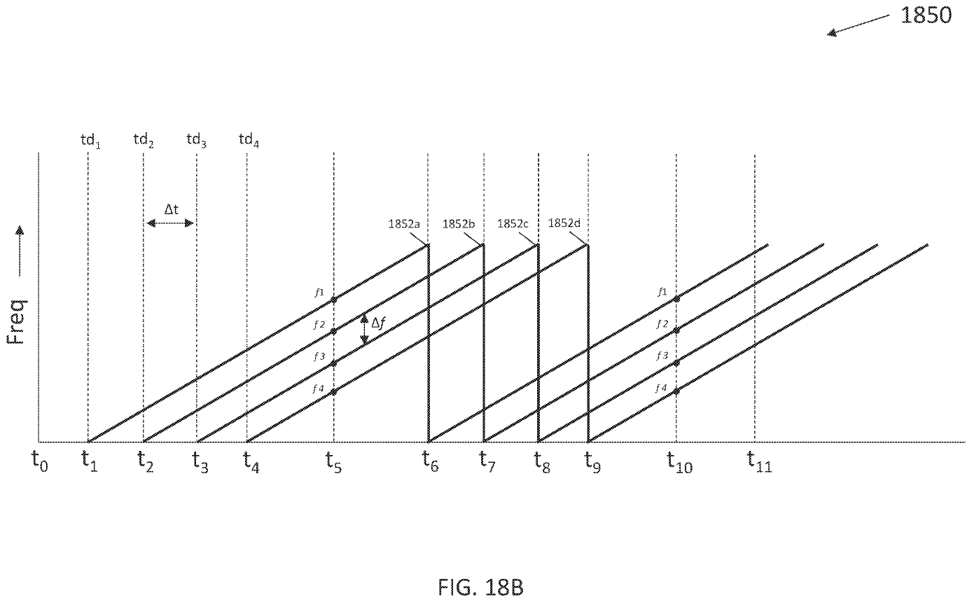

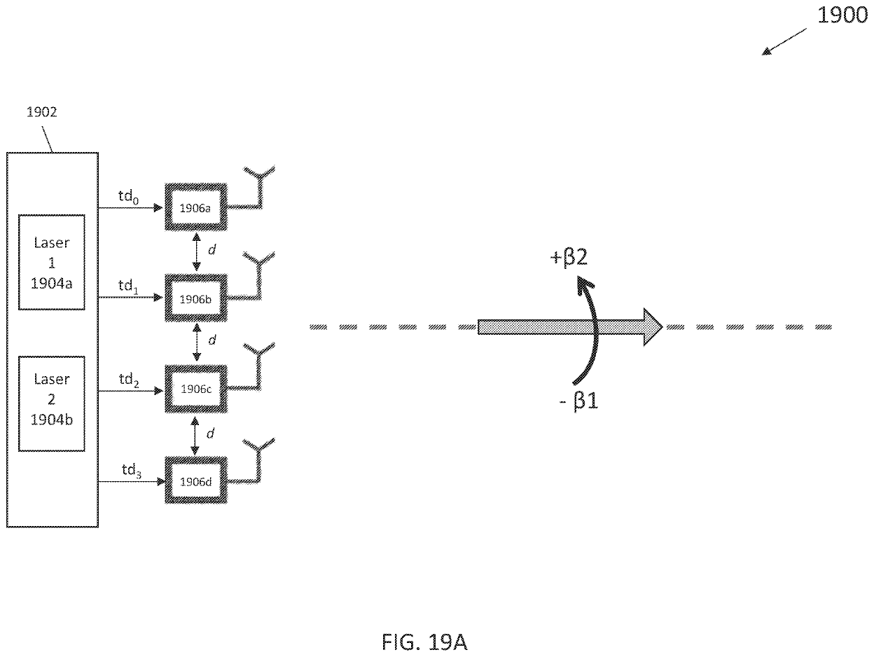

FIG. 18A illustrates an FMCW coherent LiDAR system 1800 configured to determine the range of a target in accordance with aspects described herein. In one example, the LiDAR system 1800 is similar to the FMCW coherent LiDAR system 400 of FIG. 4. For example, the LiDAR system 1800 includes a transmit/receive assembly 1802 that includes a laser 1804 configured to produce a laser signal that is “chirped” (e.g., the center frequency of the emitted laser beam is increased (“ramped up” or “chirped up”) or decreased (“ramped down” or “chirped down”) over time or, equivalently, the central wavelength λ₀ of the emitted laser beam changes with time within a waveband). Likewise, the transmit/receive assembly 1802 may include a splitter (e.g., splitter 404), a direction selective device (e.g., direction selective device 406), a coupler (e.g., coupler 412), a differential photodetector (e.g., differential photodetector 414), an ADC (e.g., ADC 416), and a target detection module (e.g., target detection module 418).

The LiDAR system 1800 includes a plurality of optical emitters 1806. In some examples, the plurality of optical emitters 1806 may correspond to (or be included in) the scanner 408 of the LiDAR system 400. In one example, each emitter of the plurality of optical emitters 1806 includes one or more optical lenses. In the illustrated example, the plurality of optical emitters 1806 includes a first emitter 1806a, a second emitter 1806b, a third emitter 1806c, and a fourth emitter 1806d; however, in other examples the plurality of optical emitters 1806 may include a different number of emitters (e.g., 2-41 emitters). The plurality of emitters 1806 may be arranged in a linear (or flat) focal plane. The emitters may be placed at discrete locations with separation d between consecutive (or adjacent) emitters. In one example, the value of d is selected such that d is less than 0.5λ₀ (i.e., less than half of the central wavelength of the laser 1804). In some examples, the value of d is selected to provide a uniform separation between the optical emitters 1806. In other examples, multiple values for d may be used to provide a non-uniform separation between the optical emitters 1806.

Each emitter of the plurality of optical emitters 1806 is configured to receive a portion of the laser signal produced by the laser 1804 after a different time delay (td). In some examples, the different time delays are provided by adjusting one or more parameters (e.g., length) of the transmission mediums or waveguides through which the laser signal propagates to reach the emitters 1806. In one example, each time delay is a multiple (e.g., integer multiple) of a predetermined time increment Δt. For example, the first emitter 1806a may receive the laser signal after a first delay td₁=Δt, the second emitter 1806b may receive the laser signal after a second delay td₂=2Δt, the third emitter 1806c may receive the laser signal after a third delay td₃=3Δt, and the fourth emitter 1806d may receive the laser signal after a fourth delay td₄=4Δt. In other examples, the first emitter 1806a may receive the laser signal after a first delay td₁=0, the second emitter 1806b may receive the laser signal after a second delay td₂=Δt, the third emitter 1806c may receive the laser signal after a third delay td₃=2Δt, and the fourth emitter 1806d may receive the laser signal after a fourth delay td₄=3Δt.

In one example, the LiDAR system 1800 is configured to provide solid-state beam steering over an optical scan range of −β1 to +β2. For example, β1 and β2 may be 90 degrees. In some examples, β1 and β2 may be unequal. In some examples, the solid-state beam steering is provided over a horizontal (e.g., x-axis) or vertical (e.g., y-axis) scan direction. In some examples, the emitters 1806 may be arranged in a two-dimensional array (e.g., in at least one row and at least one column), and the solid-state beam steering may be provided in both a horizontal (e.g., x-axis) and a vertical (e.g., y-axis) scan direction.

FIG. 18B is a graph 1850 illustrating frequency chirps as a function of time for the LiDAR system 1800. As shown, the laser 1804 is configured to provide a laser signal that ramps up (i.e., increases in frequency); however, in other examples, the laser 1804 may be configured to provide a laser signal that ramps down (i.e., decreases in frequency). As described above, each emitter receives a portion of the same laser signal (e.g., frequency chirp) with different time delays. The frequency chirp of the first emitter 1806a is depicted as solid line 1852a, the frequency chirp of the second emitter 1806b is depicted as solid line 1852b, the frequency chirp of the third emitter 1806c is depicted as solid line 1852c, and the frequency chirp of the fourth emitter 1806d is depicted as solid line 1852d.

In one example, time t₀ in the graph 1850 corresponds to the start of a scan performed by the LiDAR system 1800. At time t₁, after the first delay td₁ (e.g., Δt), a portion of the laser signal is provided to and emitted by the first emitter 1806a. After the second delay td₂ (e.g., 2Δt or td₁+Δt), a portion of the laser signal is provided to and emitted by the second emitter 1806b (at time t₂). After the third delay td₃ (e.g., 3Δt or td₂+Δt), a portion of the laser signal is provided to and emitted by the third emitter 1806c (at time t₃). Likewise, after the fourth delay td₄ (e.g., 4Δt or td₃+Δt), a portion of the laser signal is provided to and emitted by the fourth emitter 1806d (at time t₄). While the same laser signal/chirp is provided to each emitter, each emitter emits light having different frequencies at each point in time due to the staggered time delays and the time-varying frequency of the laser signal. The light emitted by consecutive emitters is separated in frequency by Δf. For example, at time t₅, the first emitter 1806a emits light having a first frequency f₁, the second emitter 1806b emits light having a second frequency f₂ (e.g., f₁−Δf), the third emitter 1806c emits light having a third frequency f₃ (e.g., f₂−Δf), and the fourth emitter 1806d emits light having a fourth frequency f₄ (e.g., f₃−Δf). Due to this frequency separation, the radiation (i.e., light) emitted by the different emitters interfere to create an FMCW beam that experiences beam steering action over the scan range −β1 to +β2. In one example, the value of the frequency separation Δf between consecutive emitters can be represented by:

$$Δ f = αΔ t$$

where, α is the frequency rate of change of the laser 1804 (i.e., the slope of frequency chirp 1852) and Δt is the time delay increment between consecutive emitters (e.g., temporally consecutive, physically adjacent emitters). As such, the frequency separation Δf between consecutive emitters can be increased by increasing the frequency rate of change of the laser 1804 and/or the time delay increment between consecutive emitters. Likewise, the frequency separation Δf between consecutive emitters can be decreased by reducing the frequency rate of change of the laser 1804 and/or the time delay increment between consecutive emitters. In some examples, the beam time (or scan time) for a full scan (e.g., a full scan of a scan line from −β1 to +β2) corresponds to 1/Δf. For example, if Δf is 500 Hz, the scan time of the LiDAR system 1800 may be approximately 1/500 Hz or 2 ms. As such, the scan time can be controlled by adjusting (i.e., increasing or decreasing) the value of Δf. In one example, the LiDAR system 1800 is configured to operate with a frequency rate of change α of approximately 0.5 GHz/μs, a time delay increment Δt of approximately 0.1 ps, and a laser bandwidth of approximately 1000 GHz.

In some examples, the frequency separation Δf between consecutive emitters may be scaled when multiple d values are used to provide a non-uniform separation between the optical emitters 1806. For example, the time delay increment Δtₙ corresponding to each emitter n may be scaled such that the relationship of dₙ×Δfₙ for each pair of consecutive emitters is constant.

As shown in FIG. 18B, the frequency chirp pattern of the laser 1804 may repeat from time to time (e.g., periodically). For example, the frequency chirp of the first emitter 1806a (depicted as solid line 1852a) may return to a minimum chirp frequency at time t₆ after reaching a maximum chip frequency. Likewise, the frequency chirp of the second emitter 1806b (depicted as solid line 1852b) may return to the minimum chirp frequency at time t₇ (e.g., t₆+Δt) after reaching the maximum chip frequency, and so on. The light emitted by the plurality of emitters 1806 may be reflected by one or more targets and used to determine the range of the target(s). In one example, the reflected light can be processed to calculate the range of the target(s) using an FMCW measurement method similar to the method described above with respect to the LiDAR system 400 of FIG. 4. In some examples, the range of the target(s) is calculated using reflected light collected only during specific measurement windows. Such measurement windows may include time periods when all emitters are emitting light along the same frequency chirp slope or, stated differently, when all consecutive emitters are emitting light with a frequency separation of Δf (e.g., time t₄ to time t₆, time t₀ to time t₁₁, etc.). In some examples, reflected light collected during other time periods (e.g., time t₁ to time t₄, time t₆ to time t₉, etc.) may be discarded and/or excluded from subsequent target range and point cloud calculations.

By emitting light having Δf frequency separation from emitters arranged with d distance separation, the radiation (i.e., light) from the different emitters can interfere to create an FMCW beam that experiences beam steering action. As such, the LiDAR system 1800 can produce a solid-state beam steering effect similar to the frequency-arrayed solid-state beam steering technique of FIGS. 13B-17 without the need of external modulation, diffraction gratings, and/or metasurface components. As such, the LiDAR system 1800 may be implemented using silicon photonics technologies.

As described above, FMCW coherent LiDAR systems can rely on two measurements having different slopes (e.g., negative and positive slopes) to measure the range and speed (or velocity) of a target simultaneously. In some examples, a single laser can be chirped up and down to provide the two measurement slopes (e.g., FIG. 5A-5B). However, in other examples, FMCW LiDAR systems can include two lasers configured to provide separate frequency chirps in parallel to determine the range and/or speed (or velocity) of a target (e.g., LiDAR systems 600, 700 of FIGS. 6, 7).

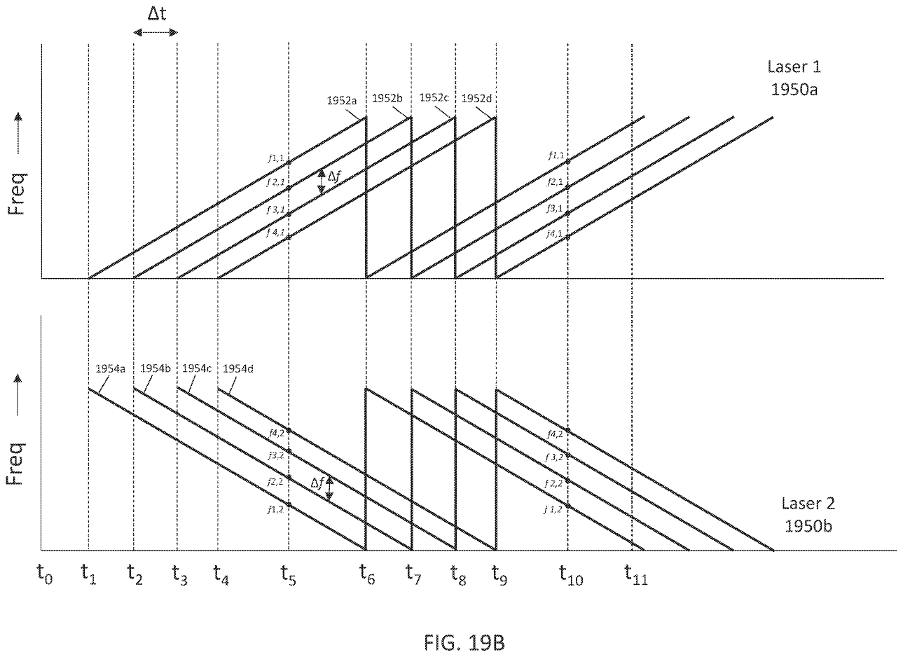

FIG. 19A illustrates an FMCW coherent LiDAR system 1900 configured to determine the range and/or speed (or velocity) of a target in accordance with aspects described herein. In one example, the LiDAR system 1900 is similar to the FMCW coherent LiDAR systems 600, 700 of FIGS. 6, 7. For example, the LiDAR system 1900 includes a transmit/receive assembly 1902 that includes a first laser 1904a and second laser 1904b. Each laser 1904a, 1904b is configured to produce a laser signal that is “chirped” (e.g., the center frequency of the emitted laser beam is increased (“ramped up” or “chirped up”) or decreased (“ramped down” or “chirped down”) over time or, equivalently, the central wavelength 2 of the emitted laser beam changes with time within a waveband). Likewise, the transmit/receive assembly 1902 may include at least one splitter (e.g., splitter 604a, 604b, 612), a combiner (e.g., combiner 606), a direction selective device (e.g., direction selective device 608), at least one coupler (e.g., coupler 614a, 614b), at least one differential photodetector (e.g., differential photodetector 616a, 616b), at least one amplifier (e.g., 618a, 618b), at least one ADC (e.g., ADC 620a, 620b), and at least one target detection module (e.g., target detection module 622a, 622b).

The LiDAR system 1900 includes a plurality of optical emitters 1906. In some examples, the plurality of optical emitters 1906 may correspond to (or be included in) a scanner (610, 710) of a LiDAR system (600, 700). In one example, each emitter of the plurality of optical emitters 1806 includes one or more optical lenses. In the illustrated example, the plurality of optical emitters 1906 includes a first emitter 1906a, a second emitter 1906b, a third emitter 1906c, and a fourth emitter 1906d; however, in other examples the plurality of optical emitters 1906 may include a different number of emitters (e.g., 2-41 emitters). The plurality of emitters 1906 may be arranged in a linear (or flat) focal plane. The emitters are placed at discrete locations with separation d between consecutive (or adjacent) emitters. In one example, the value of d is selected such that d is less than 0.5λ₀ (i.e., less than half of the central wavelengths of the lasers 1904a, 1904b). In some examples, the value of d is selected to provide a uniform separation between the optical emitters 1906. In other examples, multiple values for d may be used to provide a non-uniform separation between the optical emitters 1906.

Each emitter of the plurality of optical emitters 1906 is configured to receive portions of the laser signals produced by the lasers 1904a, 1904b after a different time delay (td). In some examples, the different time delays are provided by adjusting one or more parameters (e.g., length) of the transmission mediums or waveguides through which the laser signals propagate to reach the plurality of emitters 1906. In one example, each time delay is a multiple (e.g., integer multiple) of a predetermined time delay increment Δt. For example, the first emitter 1906a may receive portions of the laser signals after a first delay td₁=Δt, the second emitter 1906b may receive portions of the laser signals after a second delay td₂=2Δt, the third emitter 1906c may receive portions of the laser signals after a third delay td₃=3Δt, and the fourth emitter 1906d may receive portions of the laser signals after a fourth delay td₄=4Δt. In other examples, the first emitter 1906a may receive the laser signals after a first delay td₁=0, the second emitter 1906b may receive the laser signals after a second delay td₂=Δt, the third emitter 1906c may receive the laser signals after a third delay td₃=2Δt, and the fourth emitter 1906d may receive the laser signals after a fourth delay td₄=3Δt.

In one example, the LiDAR system 1900 is configured to provide solid-state beam steering over an optical scan range of −β1 to +β1. For example, β1 and β2 may be 90 degrees. In some examples, β1 and β2 may be unequal. In some examples, the solid-state beam steering is provided over a horizontal (e.g., x-axis) or vertical (e.g., y-axis) scan direction. In some examples, the emitters 1906 may be arranged in a two-dimensional array (e.g., in at least one row and at least one column), and the solid-state beam steering may be provided in both a horizontal (e.g., x-axis) and a vertical (e.g., y-axis) scan direction.

FIG. 19B includes graphs 1950a, 1950b illustrating frequency chirps as a function of time for the LiDAR system 1900. In one example, the first graph 1950a corresponds to the first laser 1904a and the second graph 1950b corresponds to the second laser 1904b.

As shown in the first graph 1950a, the first laser 1904a is configured to provide a laser signal that ramps up (i.e., increases in frequency); however, in other examples, the first laser 1904a may be configured to provide a laser signal that ramps down (i.e., decreases in frequency). As described above, each emitter receives portions of the same laser signals (e.g., frequency chirps) with different time delays. The first frequency chirp of the first emitter 1906a is depicted as solid line 1952a, the first frequency chirp of the second emitter 1906b is depicted as solid line 1952b, the first frequency chirp of the third emitter 1906c is depicted as solid line 1952c, and the first frequency chirp of the fourth emitter 1906d is depicted as solid line 1952d. Likewise, as shown in the second graph 1950b, the second laser 1904b is configured to provide a laser signal that ramps down (i.e., decreases in frequency); however, in other examples, the second laser 1904b may be configured to provide a laser signal that ramps up (i.e., increases in frequency). The second frequency chirp of the first emitter 1906a is depicted as solid line 1954a, the second frequency chirp of the second emitter 1906b is depicted as solid line 1954b, the second frequency chirp of the third emitter 1906c is depicted as solid line 1954c, and the second frequency chirp of the fourth emitter 1906d is depicted as solid line 1954d. As can be seen in FIG. 19B, a given emitter (e.g., emitter 1906a) can emit both a first frequency chirp (e.g., 1952a) and a second frequency chirp (e.g., 1954a) simultaneously.

In one example, time t₀ in graphs 1950a, 1905b corresponds to the start of a scan performed by the LiDAR system 1900. At time t₁, after the first delay td₁ (e.g., Δt), portions of the laser signals are provided to and emitted by the first emitter 1906a. After the second delay td₂ (e.g., 2Δt or td₁+Δt), portions of the laser signals are provided to and emitted by the second emitter 1906b (at time t₂). After the third delay td₃ (e.g., 3Δt or td₂+Δt), portions of the laser signals are provided to and emitted by the third emitter 1906c (at time t₃). Likewise, after the fourth delay td₄ (e.g., 4Δt or td₃+Δt), portions of the laser signals are provided to and emitted by the fourth emitter 1906d (at time t₄). While the same laser signals/chirps are provided to each emitter, each emitter emits light at two different frequencies at each point in time due to the staggered time delays. The light emitted by consecutive emitters is separated in frequency by Δf. For example, at time t₅, the first emitter 1906a emits light having first frequencies f_{1,1} and f_{1,2}, the second emitter 1906b emits light having second frequency frequencies f_{2,1} (e.g., f_{1,1}−Δf) and f_{2,2} (e.g., f_{1,2}+Δf), the third emitter 1906c emits light having third frequencies f_{3,1} (e.g., f_{2,1}−Δf) and f_{3,2} (e.g., f_{2,2}+Δf), and the fourth emitter 1906d emits light having fourth frequencies f_{4,1} (e.g., f_{3,1}−Δf) and f_{4,2} (e.g., f_{3,2}+Δf). Due to this frequency separation, the radiation (i.e., light) emitted by the different emitters can interfere to create an FMCW beam that experiences beam steering action over the scan range −β1 to +β2. In one example, the value of the frequency separation Δf between consecutive emitters can be represented by:

$$Δ f = αΔ t$$

where α is the frequency rate of change of the lasers 1904a, 1904b (i.e., the slope of frequency chirps 1952, 1954) and Δt is the time delay increment between consecutive emitters. As such, the frequency separation Δf between consecutive emitters can be increased by increasing the frequency rate of change of the lasers 1904a, 1904b and/or the time delay increment between consecutive emitters. Likewise, the frequency separation Δf between consecutive emitters can be decreased by reducing the frequency rate of change of the lasers 1904a, 1904b and/or the time delay increment between consecutive emitters. In some examples, the beam time (or scan time) for a full scan (e.g., a full scan of a scan line from −β1 to +β2) corresponds to 1/Δf. For example, if Δf is 500 Hz, the scan time of the LiDAR system 1900 may be approximately 1/500 Hz or 2 ms. As such, the scan time can be controlled by adjusting (i.e., increasing or decreasing) the value of Δf. In one example, the LiDAR system 1900 is configured to operate with a frequency rate of change α of approximately 0.5 GHz/μs, a time delay increment Δt of approximately 0.1 ps, and a laser bandwidth of approximately 1000 GHz (i.e., each laser 1904a, 1904b has a bandwidth of 1000 GHz). In one example, the angular time dependency of the beam steering action of the LiDAR system 1900 can be represented by:

$$sin θ = ( \frac{2 πα}{{k}_{o} d} ) t$$

In some examples, the frequency separation Δf between consecutive emitters may be scaled when multiple d values are used to provide a non-uniform separation between the optical emitters 1906. For example, the time delay increment Δtₙ corresponding to each emitter n may be scaled such that the relationship of dₙ×Δfₙ for each pair of consecutive emitters is constant.

As shown in FIG. 19B, the frequency chirp patterns of the lasers 1904a, 1904b may repeat from time to time (e.g., periodically). For example, the first frequency chirp of the first emitter 1906a (depicted as solid line 1952a) may return to a minimum chirp frequency at time to after reaching a maximum chirp frequency. Likewise, the second frequency chirp of the first emitter 1906a (depicted as solid line 1954a) may return to the maximum chirp frequency at time t₆ after reaching the minimum chirp frequency. The first and second frequency chirps for the other emitters may repeat in a similar manner.

In some examples, the unidirectional chirp patterns of the lasers (e.g., lasers 1904a, 1904b) may dictate the scan direction across the FOV of the system. For example, when the first laser 1904a and the second laser 1904b are configured to chirp in the same direction (e.g., up or down), the LIDAR system 1900 may scan in a first direction (e.g., left to right, right to left, etc.). In some examples, when the first laser 1904a and the second laser 1904b are configured to chirp in different directions, the LIDAR system 1900 may scan in multiple directions simultaneously. For example, if the first laser 1904a is configured to chirp up and the second laser 1904b is configured to chirp down, the light emitted by the LiDAR system 1900 corresponding to the first laser 1904a may scan in a first scan direction (e.g., left to right) and light emitted by the LiDAR system 1900 corresponding to the second laser 1904b may scan in a second scan direction (e.g., right to left). In such examples, the beat frequencies (e.g., fb₁ and fb₂) associated with reflected light received at the LIDAR system 1900 may be stored (e.g., recorded, saved, etc.) as a function of scan angle to determine the range and/or velocity of one or more targets. In other examples, the lasers 1904a, 1904b may be configured with chirp patterns to provide different scan directions across the system FOV.

The light emitted by the plurality of emitters 1906 may be reflected by one or more targets and used to determine the range of the target(s). In one example, the reflected light can be processed to calculate the range and/or velocity of the target(s) using an FMCW measurement method similar to the method described above with respect to the LiDAR system 600 of FIG. 6 (or LiDAR system 700 of FIG. 7). In some examples, the range and/or velocity of the target(s) is calculated using reflected light collected only during specific measurement windows. Such measurement windows may include time periods when all emitters are emitting light along the same frequency chirp slopes or, stated differently, when all consecutive emitters are emitting light with frequency separations of Δf (e.g., time t₄ to time t₆, time t₉ to time t₁₁, etc.). In some examples, reflected light collected during other time periods (e.g., time t₁ to time t₄, time t₆ to time t₉, etc.) may be discarded and/or excluded from subsequent target range, velocity, and point cloud calculations.

While the example above describes configuring the lasers 1904a, 1904b to chirp in a unidirectional manner (e.g., ramp up or ramp down), it should be appreciated that each laser may be configured to chirp in a bidirectional manner (e.g., ramp up and ramp down).

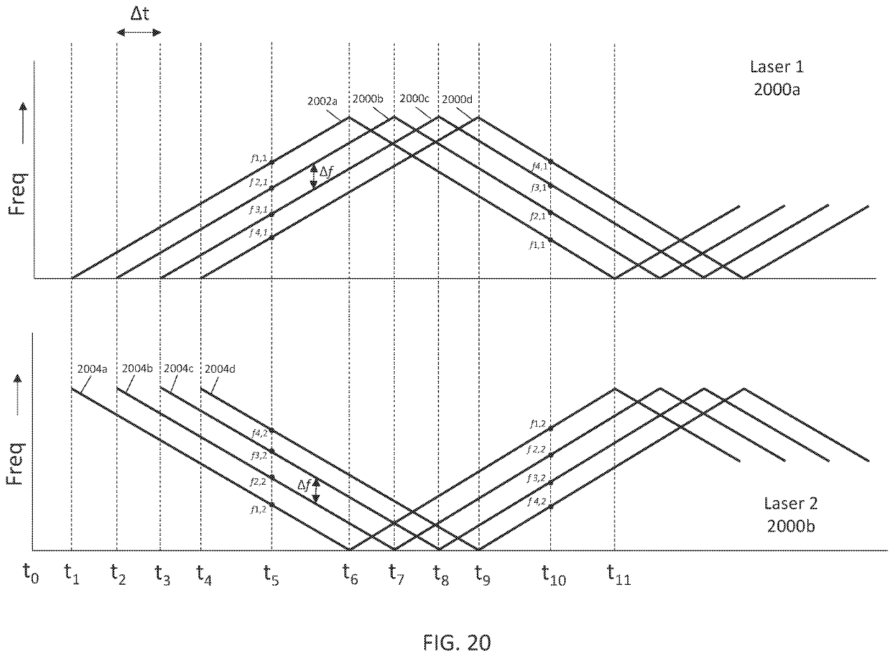

FIG. 20 includes graphs 2000a, 2000b illustrating another frequency chirp pattern as a function of time for the LiDAR system 1900. In one example, the first graph 2000a corresponds to the first laser 1904a and the second graph 2000b corresponds to the second laser 1904b.

As shown in the first graph 2000a, the first laser 1904a is configured to provide a laser signal that ramps up (i.e., increases in frequency) and then ramps down (i.e., decreases in frequency). As described above, each emitter receives portions of the same laser signals (e.g., frequency chirps) after different time delays (td). The first frequency chirp of the first emitter 1906a is depicted as solid line 2002a, the first frequency chirp of the second emitter 1906b is depicted as solid line 2002b, the first frequency chirp of the third emitter 1906c is depicted as solid line 2002c, and the first frequency chirp of the fourth emitter 1906d is depicted as solid line 2002d. Likewise, as shown in the second graph 2000b, the second laser 1904b is configured to provide a laser signal that ramps down (i.e., decreases in frequency) and then ramps up (i.e., increases in frequency). The second frequency chirp of the first emitter 1906a is depicted as solid line 2004a, the second frequency chirp of the second emitter 1906b is depicted as solid line 2004b, the second frequency chirp of the third emitter 1906c is depicted as solid line 2004c, and the second frequency chirp of the fourth emitter 1906d is depicted as solid line 2004d.

In one example, time t₀ in graphs 2000a, 2000b corresponds to the start of a scan performed by the LiDAR system 1900. At time t₁, after the first delay td₁ (e.g., Δt), portions of the laser signals are provided to and emitted by the first emitter 1906a. After the second delay td₂ (e.g., 2Δt or td₁+Δt), portions of the laser signals are provided to and emitted by the second emitter 1906b (at time t₂). After the third delay td₃ (e.g., 3Δt or td₂+Δt), portions of the laser signals are provided to and emitted by the third emitter 1906c (at time t₃). Likewise, after the fourth delay td₄ (e.g., 4Δt or td₃+Δt), portions of the laser signals are provided to and emitted by the fourth emitter 1906d (at time t₄). While the same laser signals/chirps are provided to each emitter, each emitter emits light at two different frequencies at each point in time due to the staggered time delays. The light emitted by consecutive emitters may be separated in frequency by Δf.

In some examples, the bidirectional chirp patterns of the lasers 1904a, 1904b may cause the scan directions of the system to alternate. For example, when the first laser 1904a chirps up and the second laser 1904b chirps down, the light emitted by the LiDAR system 1900 corresponding to the first laser 1904a may scan in a first scan direction (e.g., left to right) and light emitted by the LiDAR system 1900 corresponding to the second laser 1904b may scan in a second scan direction (e.g., right to left). Likewise, when the first laser 1904a chirps down and the second laser 1904b chirps up, the light emitted by the LiDAR system 1900 corresponding to the first laser 1904a may scan in the second scan direction (e.g., right to left) and light emitted by the LiDAR system 1900 corresponding to the second laser 1904b may scan in the first scan direction (e.g., left to right). In such examples, the beat frequencies (e.g., fb₁ and fb₂) associated with reflected light received at the LIDAR system 1900 may be stored (e.g., recorded, saved, etc.) as a function of scan angle to determine the range and/or velocity of one or more targets. In other examples, the lasers 1904a, 1904b may be configured with chirp patterns to provide different scan directions across the system FOV. In certain examples, the bidirectional chirp patterns may be used to provide a raster-like scan pattern (e.g., left to right, right to left, left to right, etc.).

The light emitted by the plurality of emitters 1906 may be reflected by one or more targets and used to determine the range of the target(s). In one example, the reflected light can be processed to calculate the range and/or velocity of the target(s) using an FMCW measurement method similar to the method described above with respect to the LiDAR system 600 of FIG. 6 (or LiDAR system 700 of FIG. 7). In some examples, the range and/or velocity of the target(s) is calculated using reflected light collected only during specific measurement windows. Such measurement windows may include time periods when all emitters are emitting light along the same frequency chirp slopes or, stated differently, when all consecutive emitters are emitting light with frequency separations of Δf (e.g., time t₄ to time t₆, time t₉ to time t₁₁, etc.). In some examples, reflected light collected during other time periods (e.g., time t₁ to time t₄, time t₆ to time t₉, etc.) may be discarded and/or excluded from subsequent target range, velocity, and point cloud calculations.

By emitting light having Δf frequency separation from emitters arranged with d distance separation, the radiation (i.e., light) from the different emitters can interfere to create FMCW beams that experience beam steering action. As such, the LiDAR system 1900 can produce a solid-state beam steering effect similar to the frequency-arrayed solid-state beam steering technique of FIGS. 13B-17 without the need of external modulation, diffraction gratings, and/or metasurface components. As such, the LiDAR system 1900 may be implemented using silicon photonics technologies.

While the LiDAR systems 1800, 1900 are described above as providing solid-state beam steering over a horizontal (e.g., x-axis) or vertical (e.g., y-axis) scan direction, it should be appreciated that the LiDAR systems 1800, 1900 can be used to scan in multiple directions simultaneously. For example, the LiDAR system 1800, 1900 may be included in an array of LiDAR systems (or devices). In one example, an array of LiDAR systems 1800, 1900 may be arranged in a vertical (e.g., y-axis) stack where each system (or device) is configured to provide solid-state beam steering over a horizontal (e.g., x-axis) scan direction. Likewise, an array of LiDAR systems 1800, 1900 may be arranged in a horizontal (e.g., x-axis) row where each system (or device) is configured to provide solid-state beam steering over a vertical (e.g., y-axis) scan direction. In another example, the light emitted by the LiDAR system 1800, 1900 may be redirected by one or more external scanning mirrors. For example, the LiDAR system 1800, 1900 may be configured to steer light in a horizontal (e.g., x-axis) scan direction while an external scanning mirror redirects the emitted light in vertical (e.g., y-axis) scan direction. Likewise, the LiDAR system 1800, 1900 may be configured to steer light in a vertical (e.g., y-axis) scan direction while an external scanning mirror redirects the emitted light in a horizontal (e.g., y-axis) scan direction. In other examples, at least a portion of the LiDAR system 1800, 1900 may be rotated or actuated in a scan direction. For example, the LiDAR system 1800, 1900 may be configured to provide solid-state beam steering over a vertical (e.g., y-axis) scan direction while at least a portion of the LiDAR system 1800, 1900 is rotated to scan in a horizontal (e.g., x-axis) direction. Likewise, the LiDAR system 1800, 1900 may be configured to provide solid-state beam steering over a horizontal (e.g., x-axis) scan direction while at least a portion of the LiDAR system 1800, 1900 is actuated to scan in a vertical (e.g., y-axis) direction.

In some examples, the LiDAR system 1800, 1900 may include a two-dimensional array of optical emitters (e.g., optical emitters 1806, 1906) to provide solid-state beam steering in two directions. The array of optical emitters may be arranged in a grid (e.g., 4×4, 8×8, 4×8, etc.) where each emitter has a corresponding first delay and second delay. The first delay may correspond to a horizontal (e.g., x-axis) position of each emitter relative to the other emitters and the second delay may correspond to a vertical (e.g., y-axis) position of each emitter relative to the other emitters. At least one first transmit beam can be provided to each emitter with the corresponding first delays to scan over a horizontal (e.g., x-axis) scan direction. Likewise, at least one second transmit beam can be provided to each emitter with the corresponding second delay to scan over a vertical (e.g., y-axis) scan direction. In some examples, the scans are performed during different intervals (e.g., alternating between horizontal and vertical scans). In other examples, the horizontal and vertical scans may be performed simultaneously.

Implementation with Silicon Photonic Technologies

As described above, the FMCW coherent LiDAR systems 1800, 1900 can be implemented using silicon photonics technologies. In some examples, the lack of external modulation components and/or frequency comb components (e.g., diffraction gratings, metasurfaces, etc.) enables the LiDAR systems 1800, 1900 to be suitable for implementation using silicon photonic technologies.

Silicon photonics (SiP) is a material platform from which photonic integrated circuits (PICs) can be produced. Silicon photonics is compatible with CMOS (electronic) fabrication techniques, which allows PICs to be manufactured using established foundry infrastructure. In PICs, light propagates through a patterned silicon optical medium that lies on top of an insulating material layer (e.g., silicon on Insulator (SOI)). In some cases, direct bandgap materials (e.g., indium phosphide (InP)) are used to create light (e.g., laser) sources that are integrated in an SiP chip (or wafer) to drive optical or photonic components within a photonic circuit. Silicon photonics technologies are increasingly used in optical datacom, sensing, biomedical, automotive, astronomy, aerospace, AR/VR, AI applications, navigation, identification imaging, drones, robotics, etc.

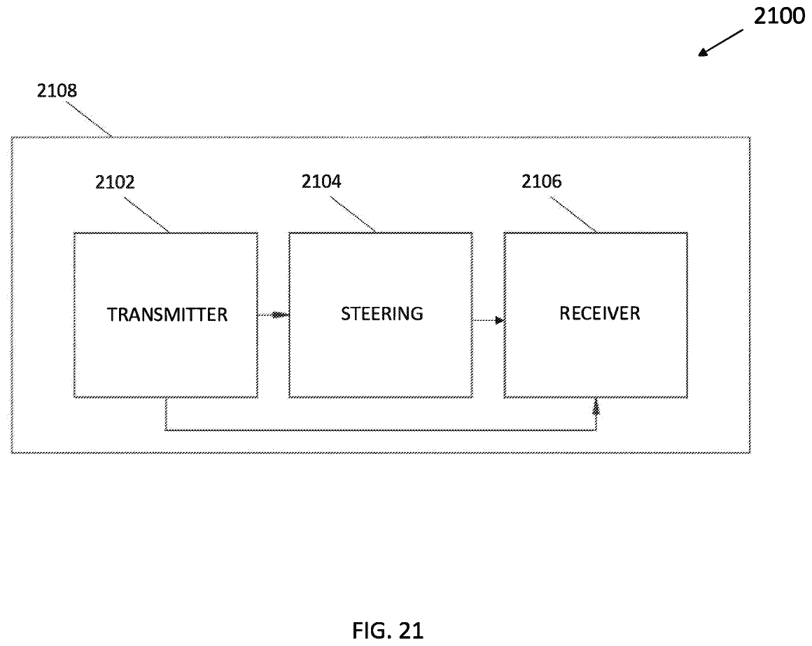

FIG. 21 is a block diagram of a silicon photonic integrated circuit (PIC) 2100 in accordance with aspects described herein. In one example, the LiDAR systems 1800, 1900 can be implemented as the PIC 2100. The PIC 2100 includes a transmitter module 2102, a steering module 2104, and a receiver module 2106. As shown, the transmitter module 2102, the steering module 2104, and the receiver module 2106 are integrated on a silicon substrate 2108. In some embodiments, the steering module 2104 is used by the PIC 2100 in connection with transmission (e.g., emission) and reception (e.g., collection) of optical signals. In some examples, the silicon substrate 2108 includes a silicon layer (e.g., 200 nm-10 micron thickness) disposed over an oxide layer (e.g., approximately 2 micron thickness). In certain examples, the silicon substrate 2108 can include multiple silicon and/or oxide layers.

In one example, the transmitter module 2102 includes at least one laser source. For example, the transmitter module 2102 can include the laser 1804 or the lasers 1904a, 1904b. In some examples, the laser source(s) are implemented using a direct bandgap material (e.g., InP) and integrated on the silicon substrate 2108 via hybrid integration. The transmitter module 2102 may also include at least one splitter (e.g., splitter 604a, 604b, 612), a combiner (e.g., combiner 606), and/or a direction selective device (e.g., direction selective device 608) that are implemented on the silicon substrate 2108 via monolithic or hybrid integration. In some examples, the laser source(s) are external to the PIC 2100 and the laser signal(s) can be provided to the transmission module 2102.

In one example, the steering module 2104 includes a plurality of optical antennas (e.g., optical emitters) and a corresponding optical feed structure. For example, the steering module 2104 can include the plurality of optical emitters 1806, 1906. In other examples, the optical antennas may be external to the PIC 2100 and the steering module 2104 may include the optical feed structure(s) coupling the transmitter module 2102 and/or the receiver module 2106 to the plurality of optical antennas. In this context, an optical antenna refers to any device capable of transmitting (or emitting) and/or receiving (or collecting) optical signals or light (e.g., in the infrared and/or visible spectrum). In some examples, each optical antenna may include at least one lens and/or at least one mirror. Any suitable optical antennas may be used including, without limitation, electrically driven Yagi-Uda antennas (see Kullock et al., Electrically-driven Yagi-Uda antennas for light, Nature Communications 11:115 (2020)), optical slot antennas, nanoantennas, nanophotonic antennas, steerable optical switched arrays, or any other suitable optical antennal (see, e.g., Alda et al., Optical antennas for nanophotonic applications, Nanotechnology 16 (2005) S230-S234). In some examples, the steering module 2104 can include couplers and phase shifting devices associated with the optical feed structure.

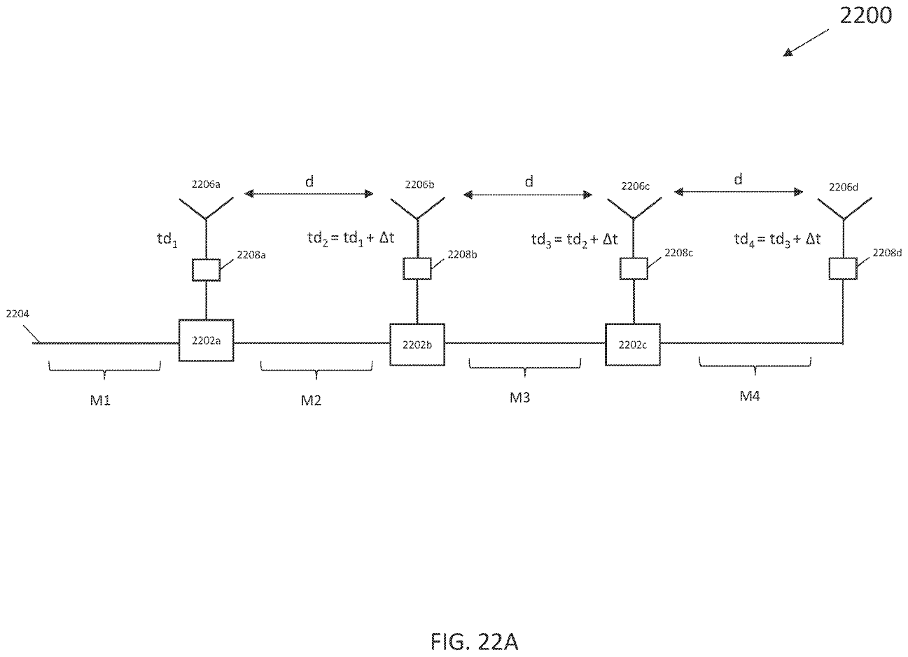

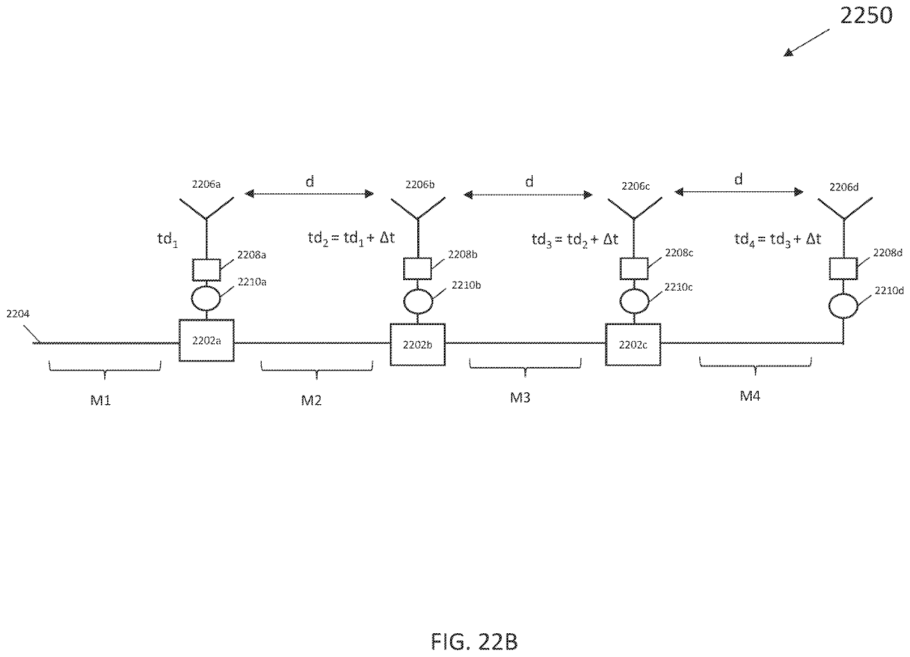

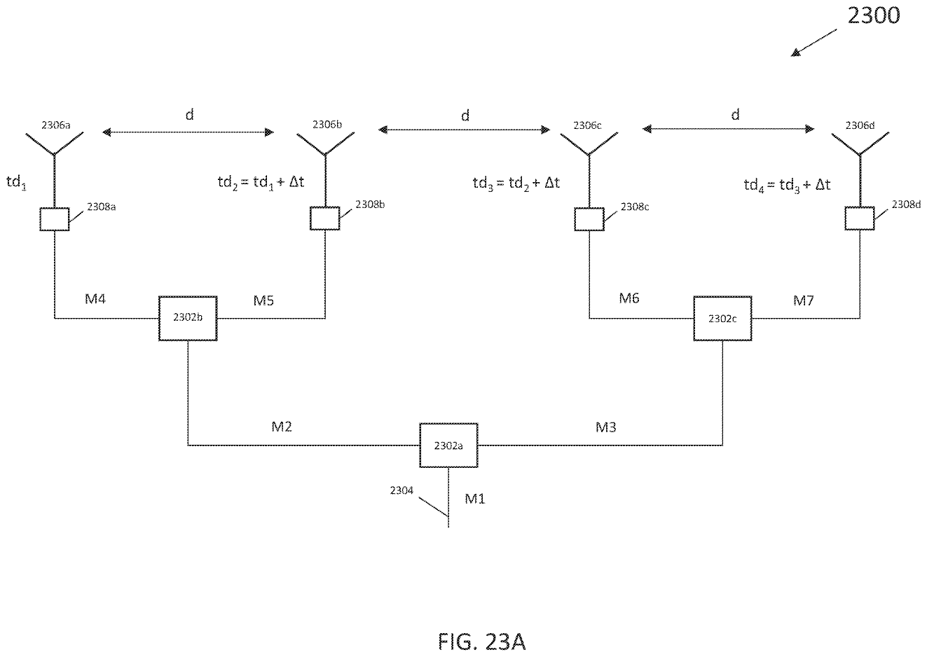

FIG. 22A illustrates an example optical feed structure 2200 in accordance with aspects described herein. In one example, the optical feed structure 2200 includes a plurality of transmission mediums M1-M4 and a plurality of couplers 2202 configured to provide at least one laser signal received at port 2204 to a plurality of optical antennas 2206.

The optical antennas 2206 may correspond to the optical emitters 1806 of the LiDAR system 1800 or the optical emitters 1906 of the LiDAR system 1900. In the illustrated example, the optical antennas 2206 include a first antenna 2206a, a second antenna 2206b, a third antenna 2206c, and a fourth antenna 2206d; however, in other examples the optical antennas 2206 may include a different number of antennas (e.g., 2-41 antennas). The antennas 2206 may be arranged in a linear (or flat) focal plane. The antennas are placed at discrete locations with separation d between consecutive (or adjacent) antennas. In one example, the value of d is selected such that d is less than 0.520 (i.e., less than half of the central wavelengths of the laser signal(s) received at port 2204). In some examples, the value of d is selected to provide a uniform separation between the optical antennas 2206. In other examples, multiple values for d may be used to provide a non-uniform separation between the optical antennas 2206.

The couplers 2202 may include N−1 couplers, where N is the number of antennas included in the plurality of optical antennas 2206. In some examples, the configuration of each coupler 2202 is scaled such that the amplitude of each signal delivered to the plurality of optical antennas 2206 is substantially the same (e.g., uniform power distribution). For example, each antenna may receive a portion of the input laser signal received at port 2204 corresponding to Pᵢ/N, where Pᵢ is the power level (or amplitude) of the laser signal received at port 2204 and N is the number of antennas. In one example, assuming N=4, the first coupler 2202a can be configured as a 75:25 coupler to deliver approximately 25% of the input laser signal to the first antenna 2206a, the second coupler 2202b can be configured as a 66:33 coupler to deliver approximately 75%*33%=25% of the input laser signal to the second antenna 2206b, and the third coupler 2202c can be configured as a 50:50 coupler to deliver approximately 75%*66%*50%=25% of the input laser signal to the third antenna 2206c and approximately 25% of the input laser signal to the fourth antenna 2206d.

In one example, the scaled configuration of the couplers 2202 is represented by the following relationships:

$$\begin{matrix}{δ}_{n} = [ ( N - 1 ) - ( n - 1 ) ] / [ N - ( n - 1 ) ] \\ {CR}_{n} = ( {δ}_{n} \times 100 ) : [ ( 1 - {δ}_{n} ) \times 100 ]\end{matrix}$$

where, N is the number of optical antennas, n is the coupler order number (e.g., first, second, third, etc.), δₙ is the coupler configuration parameter, and CRₙ is the coupler ratio. For example, assuming N=4, the coupler configuration parameter δ₁ for the first coupler 2202a may be calculated as δ₁=¾, corresponding to a coupler ratio of CR₁=75:25. The coupler configuration parameter δ₂ for the second coupler 2202b may be calculated as δ₂=⅔ corresponding to a coupler ratio of CR₂=66:33. Similarly, the coupler configuration parameter δ₃ for the third coupler 2202c may be calculated as δ₃=½ corresponding to a coupler ratio of CR₃=50:50. The couplers 2202 may be implemented via monolithic or hybrid integration on the silicon substrate 2108.

In some examples, the couplers 2202 may have a uniform configuration. For example, each coupler 2202 may be a 50:50 coupler; however, other types of couplers may be used. In such examples, the non-uniform power distribution across the plurality of antennas 2206 may be compensated for (e.g. via post-processing).

In one example, each of the transmission mediums M1-M4 is an optical waveguide. Each transmission medium M1-M4 may be a silicon medium; however, in other examples, the transmission mediums may be different mediums, such as fiber mediums or any other suitable optical transmission medium. As described above, the optical antennas 2206 are configured to receive the laser signal(s) produced by the laser(s) with different time delays to provide a frequency separation of Δf between consecutive antennas. Due to this frequency separation, the radiation (i.e., light) emitted by the different antennas can interfere to create an FMCW beam that experiences beam steering action. As such, the transmission mediums M1-M4 are configured to provide the laser signal(s) to each antenna with different delays (e.g., increments of Δt).

For example, the laser signal(s) received at port 2204 may be split by a first coupler 2202a such that a first portion of the laser signal(s) is provided to the first antenna 2206a after a first delay td₁=Δt. The first delay td₁ may correspond to a propagation time associated with the transmission medium M1. The remaining portion of the laser signal(s) is directed from the first coupler 2202a to a second coupler 2202b. The second coupler 2202b splits the laser signal(s) such that a second portion of the laser signal(s) is provided to the second antenna 2206b after a second delay td₂=2Δt (or td₁+Δt). The second delay td₂ may correspond to a combined propagation time associated with the transmission mediums M1 and M2. The remaining portion of the laser signal(s) is directed from the second coupler 2202b to a third coupler 2202c. The third coupler 2202c splits the laser signal(s) such that a third portion of the laser signal(s) is provided to the third antenna 2206c after a third delay td₃=3Δt (or td₂+Δt). The third delay td₃ may correspond to a combined propagation time associated with the transmission mediums M1-M3. A remaining fourth portion of the laser signal(s) is directed from the third coupler 2202c to the fourth antenna 2206d after a fourth delay td₄=4Δt (or td₃+Δt). The fourth delay td₄ may correspond to a combined propagation time associated with the transmission mediums M1-M4.

In one example, the propagation time associated with each transmission medium M1-M4 can be represented as:

$${t}_{p} = \frac{L}{c} n$$

where, L is the length of the transmission medium, c is the speed of light in free space, and n is the refractive index of the transmission medium. As such, the time delay associated with each transmission medium M1-M4 can be controlled by adjusting the length and/or the refractive index of the transmission medium. In some examples, controlling delay via the length of the transmission mediums is preferred. However, adjusting the refractive index of one or more transmission mediums may be advantageous when design or routing constraints are present. In some examples, the transmission mediums M1-M4 can be implemented via monolithic or hybrid integration on the silicon substrate 2108.

As described above, the scan time of the LiDAR system (e.g., the scan time of the PIC 2100) is proportional to the frequency separation of Δf between consecutive antennas. In certain examples, the frequency rate of change of the laser signal(s) a may be adjusted to fine tune the value of Δf. For example, based on design constraints of the PIC 2100, an optimal routing of the optical feed structure 2200 may result in time delay increments Δt that are too long or short to provide a desired Δf. As such, the frequency rate of change of the laser signal(s) a may be increased or decreased to tune the value of Δf relative to the value of Δt associated with an optimal design/layout of the PIC 2100. In some embodiments, the time period during which the LiDAR system performs a full scan (e.g., of a scan line) may be equal to the time period during which the LiDAR system emits a chirp. In some embodiments, the scan repetition rate (e.g., the rate at which the LiDAR system performs full scans of scan lines) may be equal to the chirp repetition rate (e.g., the rate at which the LiDAR system emits chirps).

In some examples, the optical feed structure 2200 includes phase shift devices to correct manufacturing and/or operating variances. For example, a plurality of phase shift devices 2208 may be included in the signal path of each antenna. The phase shift devices may be passive devices that provide a fixed phase shift associated with each antenna. The phase shift value provided by each antenna may be determined via a calibration process at the time of manufacturing to correct for manufacturing variances and tolerances (e.g., variances of Δt). In other examples, the phase shift devices 2208 may be active devices configured to stabilize the value of the delay associated with each antenna (e.g., td₁, td₂, etc.). For example, the delay associated with each transmission medium M1-M4 may vary with temperature. As such, the phase shift devices 2208 can provide phase shift corrections to the laser signals received at each antenna to stabilize the frequency separation of Δf between consecutive antennas during operation. In certain examples, the phase shift devices 2208 can be implemented via monolithic or hybrid integration on the silicon substrate 2108.

In some examples, the optical feed structure 2200 may be used in the transmit mode of the LiDAR system 1800, 1900 only. In other examples, the optical feed structure 2200 may be used in both the transmit and receive modes of the LiDAR system 1800, 1900. For example, the optical feed structure 2200 may operate in a bidirectional manner where reflected light received by the plurality of antennas 2206 (or another optical receiver) is redirected to port 2204 and provided to the receiver module 2106 of the PIC 2100.

FIG. 22B illustrates an example optical feed structure 2250 in accordance with aspects described herein. In one example, the optical feed structure 2250 is substantially the same as the optical feed structure 2200 of FIG. 22A, except the optical feed structure 2250 includes a plurality of power regulation devices 2210. Each power regulation device 2210 may be configured to regulate (e.g., adjust) the power of the laser signal being delivered to each antenna 2206. For example, a first power regulation device 2210a is configured to regulate the power of the laser signal (e.g., a portion of the input laser signal) being delivered to the first antenna 2206a, a second power regulation device 2210b is configured to regulate the power of the laser signal being delivered to the second antenna 2206b, a third power regulation device 2210c is configured to regulate the power of the laser signal being delivered to the third antenna 2206c, and a fourth power regulation device 2210d is configured to regulate the power of the laser signal being delivered to the fourth antenna 2206d. In other examples, a different number (or configuration) of power regulation devices can be used. For example, the third power regulation device 2210c or the fourth power regulation device 2210d may be optional. In some examples, only one or a select subset of the antennas may have respective power regulation devices.

In one example, each power regulation device 2210 includes a variable optical attenuator (VOA) and a photodetector. A sampled (e.g., tapped) portion of the laser signal being delivered to the antenna is provided to the photodetector to measure (or estimate) the power of the laser signal. The photodetector is used to provide feedback to the VOA to adjust (e.g., attenuate) the laser signal. In some examples, the plurality of power regulation devices 2210 can be operated to achieve and/or maintain a desired (e.g., uniform) power distribution across the plurality of antennas 2206.

In some examples, the plurality of couplers 2202 can be configured as active couplers (e.g., Mach-Zehnder interferometers). As such, each power regulation device 2210 may include a photodetector configured to provide feedback to the active coupler. For example, a sampled (e.g., tapped) portion of the laser signal being delivered to the antenna can be provided to the photodetector to measure (or estimate) the power of the laser signal. The power measurement may be used to adjust the coupler ratio (e.g., phase shift of the Mach-Zehnder interferometer) of the active coupler. In some examples, the plurality of power regulation devices 2210 can be operated to achieve and/or maintain a desired (e.g., uniform) power distribution across the plurality of antennas 2206 by controlling the active couplers in real-time (or at periodic intervals).

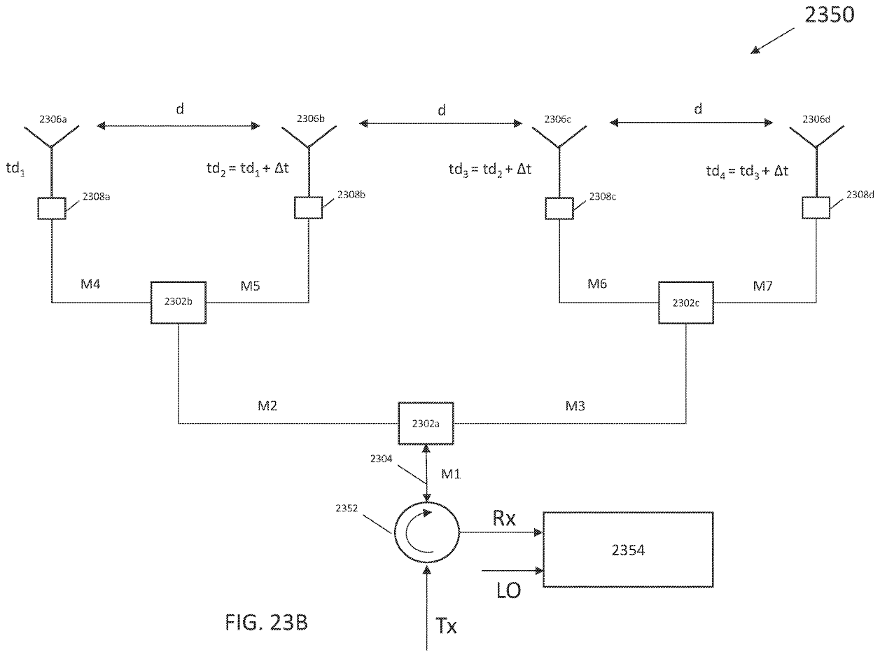

FIG. 23A illustrates another example optical feed structure 2300 in accordance with aspects described herein. In one example, the optical feed structure 2300 includes a plurality of transmission mediums M1-M7 and a plurality of couplers 2302 configured to provide at least one laser signal received at port 2304 to a plurality of optical antennas 2306. The couplers 2302 may include N−1 couplers, where N is the number of optical antennas 2306. In some examples, each coupler 2302 is a 50:50 coupler; however, other types of couplers may be used. The couplers 2302 may be implemented via monolithic or hybrid integration on the silicon substrate 2108.

The optical antennas 2306 may correspond to the optical antennas 1806 of the LiDAR system 1800 or the optical antennas 1906 of the LiDAR system 1900. In the illustrated example, the optical antennas 2306 include a first antenna 2306a, a second antenna 2306b, a third antenna 2306c, and a fourth antenna 2306d; however, in other examples the system 2300 may include a different number of antennas (e.g., 2-41 antennas). The antennas 2306 may be arranged in a linear (or flat) focal plane. The antennas may be placed at discrete locations with separation d between consecutive (or adjacent) antennas. In one example, the value of d is selected such that d is less than 0.5λ₀ (i.e., less than half of the central wavelengths of the laser signal(s) received at port 2304). In some examples, the value of d is selected to provide a uniform separation between the optical antennas 2306. In other examples, multiple values for d may be used to provide a non-uniform separation between the optical antennas 2306.

In one example, each of the transmission mediums M1-M7 is an optical waveguide. Each transmission medium M1-M7 may be a silicon medium; however, in other examples, the transmission mediums may be different mediums, such as fiber mediums or any other suitable optical transmission medium. In some examples, the transmission mediums M1-M7 can be implemented via monolithic or hybrid integration on the silicon substrate 2108.

As described above, the plurality of optical antennas 2306 are configured to receive the laser signal(s) produced by the laser(s) with different time delays to provide a frequency separation of Δf between consecutive antennas. Due to this frequency separation, the radiation (i.e., light) emitted by the different antennas can interfere to create an FMCW beam that experiences beam steering action. As such, the transmission mediums M1-M7 are configured to provide the laser signal(s) to each antenna with different delays (e.g., increments of Δt).

For example, the laser signal(s) received at port 2304 may be split by a first coupler 2302a such that a first portion of the laser signal(s) is provided to a second coupler 2302b and a second portion of the laser signal(s) is provided to a third coupler 2302c. The second coupler 2302b is configured to split the first portion of the laser signal(s) such that a third portion of the laser signal(s) is provided to the first antenna 2306a after a first delay td₁=Δt and a fourth portion of the laser signal(s) is provided to the second antenna 2306b after a second delay td₂=2Δt (or td₁+Δt). The first delay td₁ may correspond to a combined propagation time associated with the transmission mediums M1, M2, and M4. Likewise, the second delay td₂ may correspond to a combined propagation time associated with the transmission mediums M1, M2, and M5. Similarly, the third coupler 2302c is configured to split the second portion of the laser signal(s) such that a fifth portion of the laser signal(s) is provided to the third antenna 2306c after a third delay td₃=3Δt (or td₂+Δt) and a sixth portion of the laser signal(s) is provided to the fourth antenna 2306d after a fourth delay td₄=4Δt (or td₃+Δt). The third delay td₃ may correspond to a combined propagation time associated with the transmission mediums M1, M3, and M6. Likewise, the fourth delay td₄ may correspond to a combined propagation time associated with the transmission mediums M1, M3, and M7.

As described above, the propagation time associated with each transmission medium M1-M7 can be controlled by adjusting the length and/or the refractive index of the transmission medium. In certain examples, the frequency rate of change of the laser signal(s) a may be increased or decreased to tune the value of Δf relative to the value of Δt associated with an optimal routing of the optical feed structure 2300 (or the design/layout of the PIC 2100).

In some examples, the optical feed structure 2300 includes phase shift devices to correct manufacturing and/or operating variances. For example, a plurality of phase shift devices 2308 may be included in the signal path of each antenna. The phase shift devices may be passive devices that provide a fixed phase shift associated with each antenna. The phase shift value provided by each antenna may be determined via a calibration process at the time of manufacturing to correct for manufacturing variances and tolerances (e.g., variances of Δt). In other examples, the phase shift devices 2308 may be active devices configured to stabilize the value of the delay associated with each antenna (e.g., td₁, td₂, etc.). For example, the delay associated with each transmission medium M1-M7 may vary with temperature. As such, the phase shift devices 2308 can provide phase shift corrections to the laser signals received at each antenna to stabilize the frequency separation of Δf between consecutive antennas during operation. In certain examples, the phase shift devices 2308 can be implemented via monolithic or hybrid integration on the silicon substrate 2108. While not shown, in some examples the optical feed structure 2300 can include one or more power regulation devices (e.g., power regulation devices 2210 of FIG. 22B).

In some examples, the optical feed structure 2300 may be used in the transmit mode of the LiDAR system 1800, 1900 only. In other examples, the optical feed structure 2300 may be used in both the transmit and receive modes of the LiDAR system 1800, 1900. For example, the optical feed structure 2300 may operate in a bidirectional manner where reflected light received by the plurality of antennas 2306 (or another optical receiver) is redirected to port 2304 and provided to the receiver module 2106 of the PIC 2100.

FIG. 23B illustrates an example bidirectional optical feed structure 2350 in accordance with aspects described herein. In one example, the optical feed structure 2350 is substantially the same as the optical feed structure 2300 of FIG. 23A, except the optical feed structure 2350 includes a circulator 2352. The circulator 2352 is configured to provide a transmit (Tx) laser signal to the port 2304. Different portions of the Tx laser signal are then delivered to the plurality of antennas 2306 and emitted as described above with respect to FIG. 23A. A corresponding receive Rx signal is provided to an optical receiver 2354 via the circulator 2352. In one example, the optical receiver 2354 corresponds to the receiver module 2106 of FIG. 21. In some examples, the Rx signal includes different portions of reflected light received by each antenna 2306. The Rx signal is processed by the optical receiver 2354 to determine the range and/or velocity of one or more targets. An LO signal may be provided to the optical receiver 2354 and used to determine the range and/or velocity of the target(s). In some examples, the LO signal is tapped (or split) from the Tx laser signal.

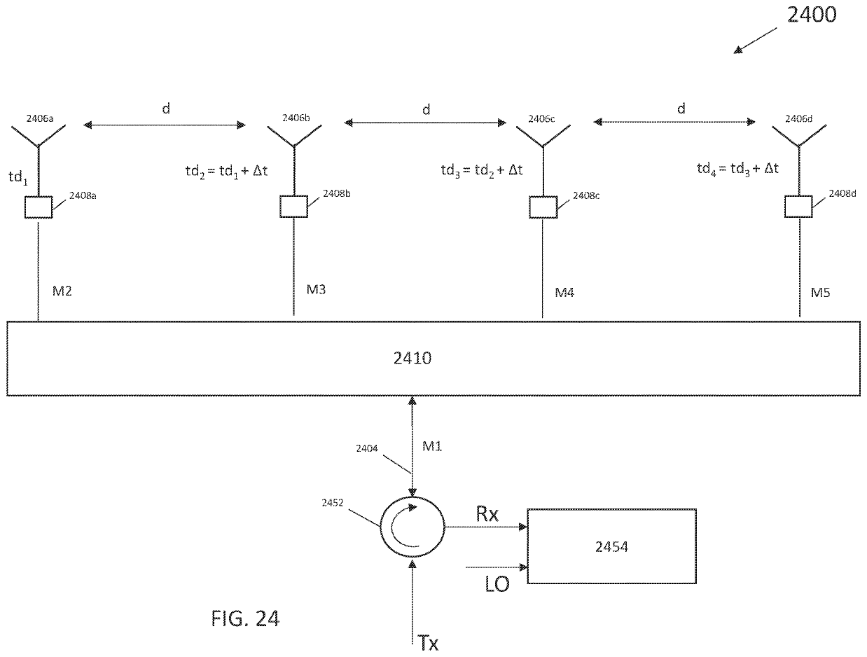

FIG. 24 illustrates an example bidirectional optical feed structure 2400 in accordance with aspects described herein. In one example, the optical feed structure 2400 includes a plurality of transmission mediums M1-M5 and a multi-mode interferometer (MMI) 2410 configured to provide portions of at least one laser signal received at port 2404 to a plurality of optical antennas 2406.

The optical antennas 2406 may correspond to the optical antennas 1806 of the LiDAR system 1800 or the optical antennas 1906 of the LiDAR system 1900. In the illustrated example, the optical antennas 2406 include a first antenna 2406a, a second antenna 2406b, a third antenna 2406c, and a fourth antenna 2406d; however, in other examples the system 2400 may include a different number of antennas (e.g., 2-41 antennas). The antennas 2406 may be arranged in a linear (or flat) focal plane. The antennas may be placed at discrete locations with separation d between consecutive (or adjacent) antennas. In one example, the value of d is selected such that d is less than 0.520 (i.e., less than half of the central wavelengths of the laser signal(s) received at port 2404). In some examples, the value of d is selected to provide a uniform separation between the optical antennas 2406. In other examples, multiple values for d may be used to provide a non-uniform separation between the optical antennas 2406.

In one example, each of the transmission mediums M1-M5 is an optical waveguide. Each transmission medium M1-M5 may be a silicon medium; however, in other examples, the transmission mediums may be different mediums, such as fiber mediums or any other suitable optical transmission medium. In some examples, the transmission mediums M1-M5 can be implemented via monolithic or hybrid integration on the silicon substrate 2108.

As described above, the plurality of optical antennas 2406 are configured to receive portions of the laser signal(s) produced by the laser(s) with different time delays to provide a frequency separation of Δf between consecutive antennas. Due to this frequency separation, the radiation (i.e., light) emitted by the different antennas can interfere to create an FMCW beam that experiences beam steering action. As such, the transmission mediums M1-M5 are configured to provide the portions of the laser signal(s) to each antenna with different delays (e.g., increments of Δt).

In one example, the MMI 2410 is configured to split the laser signal(s) received at port 2404 into substantially equal portions that are delivered to the plurality of antennas 2406. For example, a first portion of the laser signal(s) is provided to the first antenna 2406a after a first delay td₁=Δt, a second portion of the laser signal(s) is provided to the second antenna 2406b after a second delay td₂=2Δt (or td₁+Δt), a third portion of the laser signal(s) is provided to the third antenna 2406c after a third delay td₃=3Δt (or td₂+Δt), and a fourth portion of the laser signal(s) is provided to the fourth antenna 2406d after a fourth delay td₄=4Δt (or td₃+Δt). The first delay td₁ may correspond to a combined propagation time associated with the transmission mediums M1 and M2. The second delay td₂ may correspond to a combined propagation time associated with the transmission mediums M1 and M3. The third delay td₃ may correspond to a combined propagation time associated with the transmission mediums M1 and M4. The fourth delay td₄ may correspond to a combined propagation time associated with the transmission mediums M1 and M5.

As described above, the propagation time associated with each transmission medium M1-M5 can be controlled by adjusting the length and/or the refractive index of the transmission medium. In certain examples, the frequency rate of change of the laser signal(s) α may be increased or decreased to tune the value of Δf relative to the value of Δt associated with an optimal routing of the optical feed structure 2400 (or the design/layout of the PIC 2100).

In some examples, the optical feed structure 2400 includes phase shift devices to correct (e.g., compensate for) manufacturing and/or operating variances. For example, one or more phase shift devices 2408 may be included in the signal path of each antenna. The phase shift devices may be passive devices that provide a fixed phase shift associated with each antenna. The phase shift value provided by each antenna may be determined via a calibration process at the time of manufacturing to correct for manufacturing variances and tolerances (e.g., variances of Δt). In other examples, the phase shift devices 2408 may be active devices configured to stabilize the value of the delay associated with each antenna (e.g., td₁, td₂, etc.). For example, the delay associated with each transmission medium M1-M5 may vary with temperature. As such, the phase shift devices 2408 can provide phase shift corrections to the laser signals received at each antenna to stabilize the frequency separation of Δf between consecutive antennas during operation. In certain examples, the phase shift devices 2408 can be implemented via monolithic or hybrid integration on the silicon substrate 2108. While not shown, in some examples the optical feed structure 2400 can include one or more power regulation devices (e.g., power regulation devices 2210 of FIG. 22B).

In one example, the optical feed structure 2400 includes a circulator 2452. The circulator 2452 is configured to provide a transmit (Tx) laser signal to the port 2404. Different portions of the Tx laser signal are then delivered to the plurality of antennas 2406 and emitted as described above. A corresponding receive Rx signal is provided to an optical receiver 2454 via the circulator 2452. In one example, the optical receiver 2454 corresponds to the receiver module 2106 of FIG. 21. In some examples, the Rx signal includes different portions of reflected light received by each antenna 2406. The Rx signal is processed by the optical receiver 2454 to determine the range and/or velocity of one or more targets. An LO signal may be provided to the optical receiver 2454 and used to determine the range and/or velocity of the target(s). In some examples, the LO signal is tapped (or split) from the Tx laser signal.

Returning to FIG. 21, the receiver module 2106 includes one or more components for receiving and processing the reflected light signals. For example, the receiver module 2106 can include a direction selective device (e.g., direction selective device 608), at least one coupler (e.g., coupler 614a, 614b), at least one differential photodetector (e.g., differential photodetector 616a, 616b), and/or at least one amplifier (e.g., 618a, 618b) that are implemented on the Silicon substrate 2108 via monolithic or hybrid integration. In some examples, the receiver module 2106 is configured to provide signals to at least one ADC (e.g., ADC 620a, 620b) and at least one target detection module (e.g., 622a, 622b). The ADC(s) and target detection module(s) may be included in the receiver module 2106 or external to the receiver module 2106.

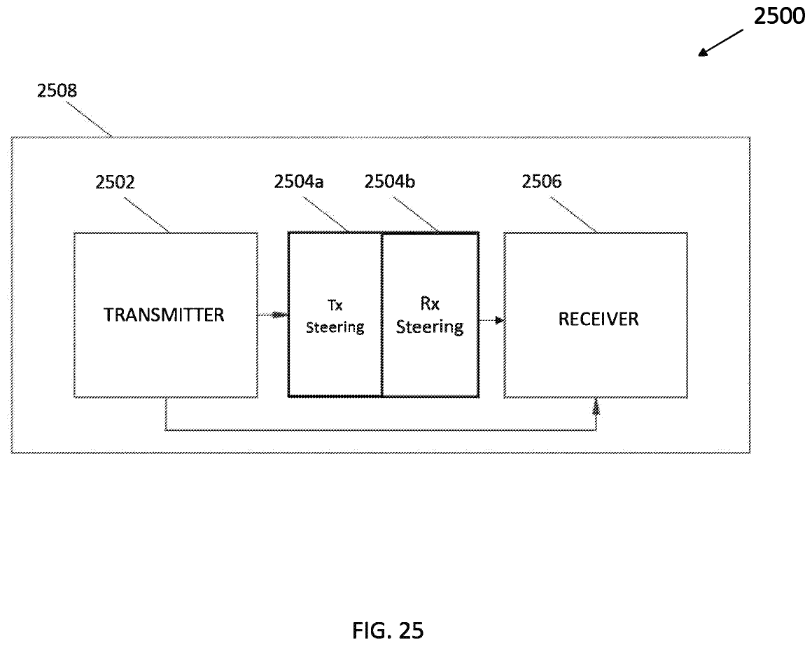

FIG. 25 is a block diagram of another silicon photonic integrated circuit (PIC) 2500 in accordance with aspects described herein. In one example, the LiDAR systems 1800, 1900 can be implemented as the PIC 2500. The PIC 2500 includes a transmitter module 2502, a steering module 2504, and a receiver module 2506. As shown, the transmitter module 2502, the steering module 2504, and the receiver module 2506 are integrated on a silicon substrate 2508. In some examples, the silicon substrate 2508 includes a silicon layer (e.g., 200 nm-10 micron thickness) disposed over an oxide layer (e.g., approximately 2 micron thickness). In certain examples, the silicon substrate 2508 can include multiple silicon and/or oxide layers.

In one example, the transmitter module 2502 includes at least one laser source. For example, the transmitter module 2502 can include the laser 1804 or the lasers 1904a, 1904b. In some examples, the laser source(s) are implemented using a direct bandgap material (e.g., InP) and integrated on the silicon substrate 2508 via hybrid integration. The transmitter module 2502 may also include at least one splitter (e.g., splitter 604a, 604b, 612), a combiner (e.g., combiner 606), and/or a direction selective device (e.g., direction selective device 608) that are implemented on the silicon substrate 2508 via monolithic or hybrid integration. In some examples, the laser source(s) are external to the PIC 2500 and the laser signal(s) can be provided to the transmission module 2502.

In one example, the steering module 2504 includes a transmit Tx steering module 2504a (e.g., for use by the PIC 2500 in connection with transmission of optical signals) and a receive Rx steering module 2504b (e.g., for use by the PIC 2500 in connection with reception of optical signals). The Tx steering module 2504a includes a plurality of optical antennas and a corresponding optical feed structure. For example, the Tx steering module 2504a can include the plurality of optical emitters 1806, 1906. In some examples, the Tx steering module 2504 can include any of the optical feed structures 2200, 2250, and 2300. In other examples, the optical antennas may be external to the PIC 2500 and the Tx steering module 2504a may include the optical feed structure(s) coupling the transmitter module 2502 to the plurality of optical antennas. In some examples, the Tx steering module 2504a can include couplers and phase shifting devices associated with the optical feed structure. Likewise, the Rx steering module 2504b includes a plurality of optical collectors (e.g., antennas) and a corresponding optical return structure. In one example, the plurality of optical collectors may be similar to the plurality of optical emitters 1806, 1906. In some examples, the Rx steering module 2504b can include an optical return structure that is similar to any of the optical feed structures 2200, 2250, and 2300. In other examples, the optical collectors may be external to the PIC 2500 and the Rx steering module 2504b may include the optical return structure(s) coupling the receiver module 2506 to the plurality of optical collectors. In some examples, the Rx steering module 2504b can include couplers and phase shifting devices associated with the optical return structure.

In one example, the receiver module 2506 includes one or more components for receiving and processing the reflected light signals. For example, the receiver module 2506 can include a direction selective device (e.g., direction selective device 608), at least one coupler (e.g., coupler 614a, 614b), at least one differential photodetector (e.g., differential photodetector 616a, 616b), and/or at least one amplifier (e.g., 618a, 618b) that are implemented on the Silicon substrate 2508 via monolithic or hybrid integration. In some examples, the receiver module 2506 is configured to provide signals to at least one ADC (e.g., ADC 620a, 620b) and at least one target detection module (e.g., 622a, 622b). The ADC(s) and target detection module(s) may be included in the receiver module 2506 or external to the receiver module 2506.

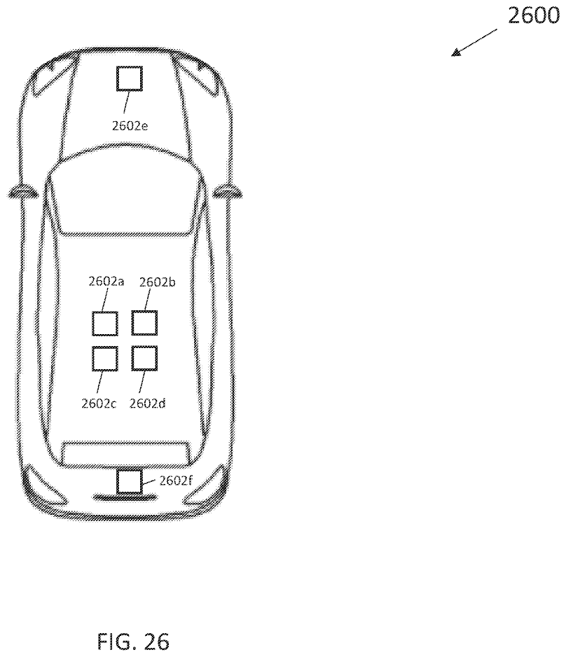

FIG. 26 illustrates a vehicle 2600 including a plurality of sensors 2602 in accordance with aspects described herein. As shown, a first sensor 2602a, a second sensor 2602b, a third sensor 2602c, and a fourth sensor 2602d may be positioned in a first location on (or inside) the vehicle 2600 (e.g., the roof). Likewise, a fifth sensor 2602e may be positioned in a second location on (or inside) the vehicle 2600 (e.g., the front of the vehicle 2600) and a sixth sensor 2602f may be positioned in a third location on (or inside) the vehicle 2600 (e.g., the back of the vehicle 2600). In other examples, a different number or configuration of sensors may be used.

In some examples, at least one sensor of the plurality of sensors 2602 is configured to provide (or enable) 3-D mapping of the vehicle's surroundings. In certain examples, at least one sensor of the plurality of sensors 2602 is used to provide navigation for the vehicle 2600 within an environment. In one example, each sensor 2602 includes at least one LiDAR system, device, or chip. The LiDAR system(s) included in each sensor 2602 may correspond to the FMCW coherent LiDAR systems 1800, 1900 of FIGS. 18A, 19A. In some examples, at least one sensor of the plurality of sensors 2602 may be a different type of sensor (e.g., camera, radar, etc.). In one example, the vehicle 2600 is a car; however, in other examples, the vehicle 2600 may be a truck, boat, plane, drone, vacuum cleaner (e.g., robot vacuum cleaner), robot, train, tractor, ATV, or any other type of vehicle or moveable object.

As described above, improved systems and methods for providing FMCW coherent LiDAR systems with solid-state beam steering are provided herein. In at least one embodiment, a LiDAR system includes at least one laser configured to provide at least one frequency chirp to determine the range and/or speed (or velocity) of a target. In one example, the at least one frequency chirp is provided to a plurality of emitters with different time delays to provide solid-state beam steering over the FOV of the LiDAR system. In some examples, the LiDAR system is implemented using Silicon photonic technologies.

### Some Examples of Computing Devices and Information Handling Systems

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price.

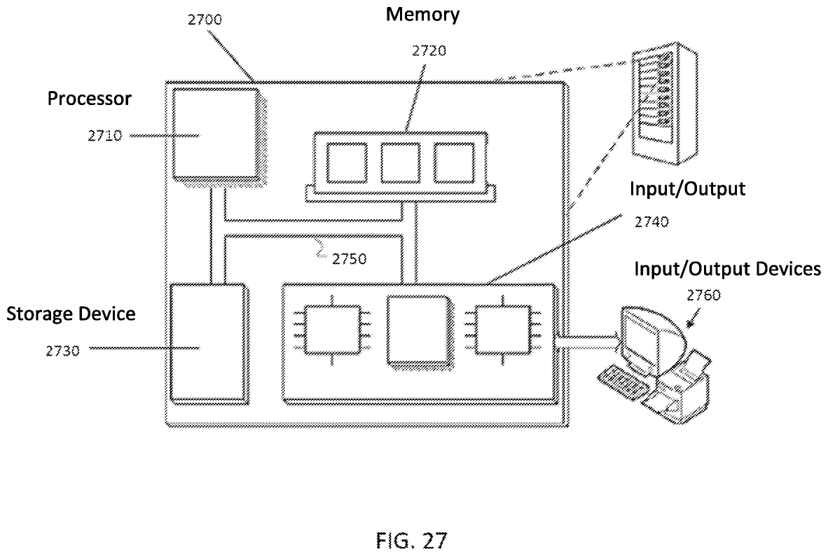

FIG. 27 is a block diagram of an example computer system 2700 that may be used in implementing the technology described in this document. General-purpose computers, network appliances, mobile devices, or other electronic systems may also include at least portions of the system 2700. The system 2700 includes a processor 2710, a memory 2720, a storage device 2730, and an input/output device 2740. Each of the components 2270, 2720, 2730, and 2740 may be interconnected, for example, using a system bus 2750. The processor 2710 is capable of processing instructions for execution within the system 2700. In some implementations, the processor 2710 is a single-threaded processor. In some implementations, the processor 2710 is a multi-threaded processor. The processor 2710 is capable of processing instructions stored in the memory 2720 or on the storage device 2730.

The memory 2720 stores information within the system 2700. In some implementations, the memory 2720 is a non-transitory computer-readable medium. In some implementations, the memory 2720 is a volatile memory unit. In some implementations, the memory 2720 is a non-volatile memory unit.

The storage device 2730 is capable of providing mass storage for the system 2700. In some implementations, the storage device 2730 is a non-transitory computer-readable medium. In various different implementations, the storage device 2730 may include, for example, a hard disk device, an optical disk device, a solid-date drive, a flash drive, or some other large capacity storage device. For example, the storage device may store long-term data (e.g., database data, file system data, etc.). The input/output device 2740 provides input/output operations for the system 2700. In some implementations, the input/output device 2740 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 2760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 2730 may be implemented in a distributed way over a network, for example as a server farm or a set of widely distributed servers, or may be implemented in a single computing device.

Although an example processing system has been described in FIG. 27, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

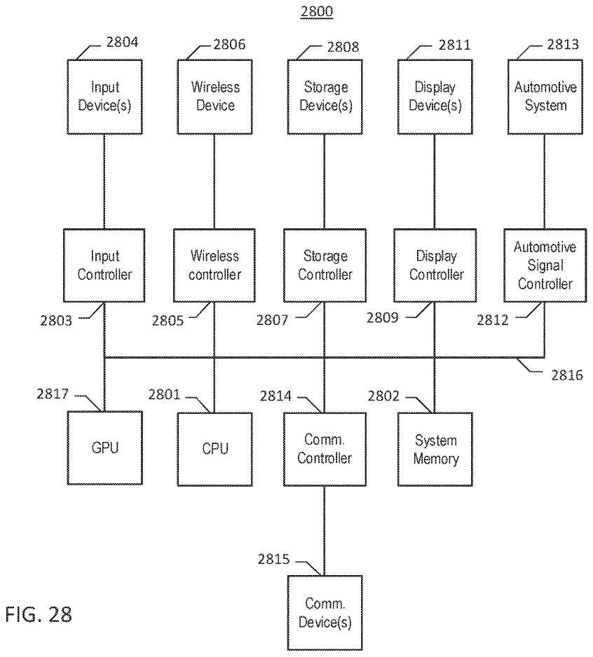

FIG. 28 depicts a simplified block diagram of a computing device/information handling system (or computing system) according to embodiments of the present disclosure. It will be understood that the functionalities shown for system 2800 may operate to support various embodiments of an information handling system—although it shall be understood that an information handling system may be differently configured and include different components.

As illustrated in FIG. 28, system 2800 includes one or more central processing units (CPU) 2801 that provide(s) computing resources and control(s) the computer. CPU 2801 may be implemented with a microprocessor or the like, and may also include one or more graphics processing units (GPU) 2817 and/or a floating point coprocessor for mathematical computations. System 2800 may also include a system memory 2802, which may be in the form of random-access memory (RAM), read-only memory (ROM), or both.

A number of controllers and peripheral devices may also be provided. For example, an input controller 2803 represents an interface to various input device(s) 2804, such as a keyboard, mouse, or stylus. There may also be a scanner controller 2805, which communicates with a scanner 2806. System 2800 may also include a storage controller 2807 for interfacing with one or more storage devices 2808 each of which includes a storage medium such as magnetic tape or disk, or an optical medium that might be used to record programs of instructions for operating systems, utilities, and applications, which may include embodiments of programs that implement various aspects of the techniques described herein. Storage device(s) 2808 may also be used to store processed data or data to be processed in accordance with some embodiments. System 2800 may also include a display controller 2809 for providing an interface to a display device 2811, which may be a cathode ray tube (CRT), a thin film transistor (TFT) display, or other type of display. The computing system 2800 may also include an automotive signal controller 2812 for communicating with an automotive system 2813. A communications controller 2814 may interface with one or more communication devices 2815, which enables system 2800 to connect to remote devices through any of a variety of networks including the Internet, a cloud resource (e.g., an Ethernet cloud, an Fiber Channel over Ethernet (FCOE)/Data Center Bridging (DCB) cloud, etc.), a local area network (LAN), a wide area network (WAN), a storage area network (SAN), or through any suitable electromagnetic carrier signals including infrared signals.

In the illustrated system, all major system components may connect to a bus 2816, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A light detection and ranging (LiDAR) device, comprising:
at least one laser source configured to provide at least one source beam having a modulated frequency;
a plurality of optical antennas configured to emit respective portions of light corresponding to the at least one source beam, the plurality of optical antennas being positioned at discrete locations with respective separations between consecutive antennas; and
an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas,
wherein the respective portions of light emitted by the plurality of optical antennas interfere to produce at least one transmit beam and to provide beam steering of the at least one transmit beam over a scan range.

2. The LiDAR device of claim 1, wherein the respective portions of light emitted by the plurality of optical antennas interfere to provide the beam steering based on the different time delays associated with the plurality of optical antennas.

3. The LiDAR device of claim 1, wherein each time delay is a different integer multiple of the time increment Δt.

4. The LiDAR device of claim 1, wherein the beam steering is solid-state beam steering.

5. The LiDAR device of claim 1, wherein the respective separations between each pair of consecutive antennas are uniform across the plurality of antennas.

6. The LiDAR device of claim 1, wherein the respective separations between each pair of consecutive antennas are non-uniform across the plurality of optical emitters.

7. The LiDAR device of claim 1, wherein the at least one source beam includes a plurality of continuous linear chirps.

8. The LiDAR device of claim 7, wherein the at least one transmit beam is steered over the scan range during each continuous linear chirp of the plurality of continuous linear chirps.

9. The LiDAR device of claim 1, wherein the plurality of optical antennas are configured to receive respective portions of light reflected by at least one target.

10. The LiDAR device of claim 9, wherein the optical feed structure is configured to provide the respective portions of reflected light to a receiver to determine a range and/or velocity of the at least one target.

11. The LiDAR device of claim 9, further comprising a second optical feed structure coupled to the plurality of optical antennas, the second optical feed structure being configured to provide the respective portions of reflected light to a receiver to determine a range and/or velocity of the at least one target.

12. The LiDAR device of claim 1, further comprising a second plurality of optical antennas configured to receive respective portions of light reflected by at least one target.

13. The LiDAR device of claim 12, wherein the optical feed structure is coupled to the second plurality of optical antennas and configured to provide the respective portions of reflected light to a receiver to determine a range and/or velocity of the at least one target.

14. The LiDAR device of claim 12, further comprising a second optical feed structure coupled to the second plurality of optical antennas, the second optical feed structure being configured to provide the respective portions of reflected light to a receiver to determine a range and/or velocity of the at least one target.

15. The LiDAR device of claim 1, wherein the at least one source beam is a frequency modulated continuous wave (FMCW) beam.

16. A vehicle comprising:
at least one light detection and ranging (LiDAR) device configured to provide navigation and/or mapping for the vehicle, the at least one LiDAR device being disposed in an interior of the vehicle and/or on an exterior of the vehicle, wherein each LiDAR device comprises:
at least one laser source configured to provide at least one source beam having a modulated frequency;
a plurality of optical antennas configured to emit respective portions of light corresponding to the at least one source beam, the plurality of optical antennas being positioned at discrete locations with respective separations between consecutive antennas; and
an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas,
wherein the respective portions of light emitted by the plurality of optical antennas interfere to produce at least one transmit beam and to provide beam steering of the at least one transmit beam over a scan range.

17. A mobile robot comprising:
at least one light detection and ranging (LiDAR) device configured to provide navigation and/or mapping for the mobile robot, the at least one LiDAR device being disposed in an interior of the mobile robot and/or on an exterior of the mobile robot, wherein each LiDAR device comprises:
at least one laser source configured to provide at least one source beam having a modulated frequency;
a plurality of optical antennas configured to emit respective portions of light corresponding to the at least one source beam, the plurality of optical antennas being positioned at discrete locations with respective separations between consecutive antennas; and
an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas,
wherein the respective portions of light emitted by the plurality of optical antennas interfere to produce at least one transmit beam and to provide beam steering of the at least one transmit beam over a scan range.

18. A method for operating a light detection and ranging (LiDAR) device, the method comprising:
providing, via at least one laser source, at least one source beam having a modulated frequency;
emitting, via a plurality of optical antennas, respective portions of light corresponding to the at least one source beam, the plurality of optical antennas being positioned at discrete locations with respective separations between consecutive antennas; and
providing, via an optical feed structure, respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas,
wherein the respective portions of light emitted by the plurality of optical antennas interfere to produce at least one transmit beam and to provide beam steering of the at least one transmit beam over a scan range.

19. A silicon photonics (SiP) device, comprising:
a plurality of optical antennas configured to emit respective portions of light corresponding to at least one source beam having a modulated frequency, the plurality of optical antennas being positioned at discrete locations with respective separations between consecutive antennas; and
an optical feed structure configured to provide respective portions of the at least one source beam to the plurality of optical antennas such that each antenna receives a respective portion of the at least one source beam with a different time delay, the time delays of consecutive antennas being separated by a time increment Δt corresponding to a frequency separation Δf of emitted light between the consecutive antennas,
wherein the respective portions of light emitted by the plurality of optical antennas interfere to produce at least one transmit beam and to provide beam steering of the at least one transmit beam over a scan range.

20. The SiP device of claim 19, further comprising at least one laser source configured to provide the at least one source beam.

21-37. (canceled)
